(19) United States
(12) Patent Application Publication
(10) Pub. No.: US 2011/0229282 A1
(43) Pub. Date: Sep. 22, 2011

(54) GEAR MACHINING APPARATUS AND MACHINING METHOD

(75) Inventors: Katsuyoshi Ohno, Shizuoka-ken (JP); Tatsuo Yokoi, Shizuoka-ken (JP); Nobuaki Ogawa, Hiroshima-ken (JP); Kenji Narahashi, Hyogo-ken (JP); Shimpei Nakada, Hyogo-ken (JP)

(73) Assignees: HONDA MOTOR CO., LTD., Tokyo (JP); SANYOMACHINE CO., LTD., Fukuyama-shi, Hiroshima (JP)

(21) Appl. No.: 12/671,593

(22) PCT Filed: Jul. 30, 2008
(86) PCT No.: PCT/JP2008/064073

§ 371 Date: Apr. 20, 2010

(30) Foreign Application Priority Data
Aug. 2, 2007 (JP) 2007-202408
Aug. 2, 2007 (JP) 2007-202410
Aug. 2, 2007 (JP) 2007-202411

(51) Int. Cl. B23F 19/10; B23F 17/00; B23F 19/06

(52) U.S. Cl. 409/8

(57) ABSTRACT

A machining section of a gear machining apparatus includes a workpiece support in the form of a shaft that pivotally supports the workpiece gear and a cutter support in the form of a shaft that supports the chamfering cutter so that the chamfering cutter meshes with the workpiece gear attached to the shaft. The shaft is angled so that the chamfering cutter meshes with the workpiece gear at an axis-crossing angle to being zero degree and machining teeth of the chamfering cutter do not interfere with a tooth face the workpiece gear. A gear machining method is also provided.

### TECHNICAL FIELD

The present invention relates to a gear machining apparatus and a machining method for appropriately chamfering end edges of a gear.

### BACKGROUND ART

Silence and durability as well as high power are required for recent motor vehicles. Accordingly, more accurate tooth face than ever is demanded on a gear used for transmitting power (e.g., gearbox) so as not to generate noise while securely transmitting the power.

Such a highly precise gear is typically produced by: rough cutting using a hob; chamfering; shaping tooth faces by a shaving cutter; carburizing and hardening by a thermal treatment; and, in order to further improve accuracy, gear-grinding and gear-honing.

In the above processes, immediately after completion of the rough cutting by a hob, end edges of tooth faces remain sharp, which may be excessively carburized during the thermal treatment and be undesirably “vitrified” (brittle) when hardened. Accordingly, the gear is subjected to the chamfering process to prevent excessive carburization and to improve gear strength.

During the chamfering, a chamfering cutter that collapses the end edges of the tooth faces of a workpiece gear is widely used. The chamfering cutter meshes with a workpiece gear without an axis-crossing angle to collapse the edge of the gear. Such machining method is disclosed, for instance, in Japanese Laid-Open Patent Publication No. 54-015596 and Japanese Laid-Open Patent Publication No. 61-284318. In Japanese Laid-Open Patent Publication No. 54-015596, it is disclosed that a chamfering cutter is meshed with a workpiece gear at an axis-crossing angle 0°. Japanese Laid-Open Patent Publication No. 61-284318 teaches that a chamfering cutter is meshed with a workpiece gear at a predetermined axis-crossing angle.

Further, Japanese Laid-Open Patent Publication No. 2006-224228 discloses a gear machining apparatus that successively conducts a tooth-cutting and end-machining in a single apparatus.

As discussed above, rough cutting, chamfering by a chamfering cutter, shaping tooth faces using a shaving cutter, thermal treatment, gear-grinding and gear-honing are typically conducted in order to manufacture a highly precise gear on which high power output, silence and durability are required.

The chamfering process with a chamfering cutter allows appropriate chamfering of the end edges of the tooth faces. However, since the end edges are fundamentally collapsed during the chamfering process, excess material is laterally pushed out, which generates a swollen portion.

Such swollen portion can be removed by the subsequent grinding process. However, since the gear has been subjected to a thermal treatment before the grinding process, the swollen portion is considerably hardened. Accordingly, great load is applied on a grinding tool and a long time is required for grinding. Further, since extra cost is required, it is preferable in terms of production efficiency that the grinding process is skipped.

If the grinding process is not conducted, however, extremely large load is applied on a grinding stone during the subsequent gear-honing, which is not preferable. This is because the hardness of the workpiece gear is increased after the thermal treatment and the gear-honing grinding stone and the workpiece gear are brought into contact at the same portion during the process, so that only the portion in contact with the swollen portion is extremely worn.

The tool disclosed in the above Japanese Laid-Open Patent Publication No. 61-284318 meshes the chamfering cutter with the workpiece gear at the predetermined axis-crossing angle. However, when such axis-crossing angle is indeliberately provided, the tooth end of the chamfering cutter interferes with the tooth face of the workpiece gear. Further, it is difficult to manufacture the tool since serrations as a cutting edge are provided on the tooth face of the tool.

Further, though the shaving process conducted after the chamfering restrains the swollen section, considerably longer time is required for the shaving process than the chamfering process. Accordingly, so-called takt time is lengthened and extra waiting time may be required after completion of the chamfering until the subsequent shaving process.

On the other hand, even when a gear which requires relatively low accuracy and is not thermally treated is to be finished (e.g., shaved), if no countermeasure for the swollen portion generated by chamfering by a chamfering cutter is taken before tooth-finishing (e.g., shaving), the swollen portion causes a load on a tool and the lifetime of the tool is necessarily shortened, which may result in more frequent suspension of the machine tool for replacing the tool, more frequent maintenance and check work, and increase in tool cost.

### DISCLOSURE OF INVENTION

An object of the present invention is to provide a gear machining apparatus and machining method capable of appropriately chamfering an end edge of a tooth face and restraining formation of a swollen portion adjacent to the end edge.

Another object of the invention is to provide a gear machining apparatus and machining method capable of efficient machining.

First feature: a gear machining apparatus according to an aspect of the invention includes: a workpiece support that pivotally supports a workpiece gear; and a cutter support that pivotally supports a chamfering cutter so that the chamfering cutter meshes with the workpiece gear attached to the workpiece support, the cutter support being angled so that the chamfering cutter meshes with the workpiece gear at an axis-crossing angle ψ (ψ≠0) and teeth of the chamfering cutter do not interfere with a tooth face of the workpiece gear.

Since the chamfering cutter meshes with the workpiece gear with the axis-crossing angle ψ, the chamfering cutter not only collapses end edges of the workpiece gear to chamfer the end edges but also restrains formation of the swollen portion on account of excess material caused by the collapsing. Further, the teeth of the chamfering cutter do not interfere with the tooth face of the workpiece gear, thereby allowing appropriate chamfering process.

Second feature: the axis-crossing angle (ψ) being represented by the following formula:

$$Ψ ≦ {cos}^{- 1} \{ \frac{( \frac{D B G \times π}{Zg} - S B G ) + A \times tan ( B O G ) - {1}_{2} \times tan ( B O G )}{S K C} \} , \qquad ( 2 )$$

where: BOG represents a gear deflection angle; SBG represents a circular thickness on a pitch circle; DBC represents a gear-meshing circle diameter (i.e., pitch diameter) of the chamfering cutter; 1₂ represents a lap value; SKC represents a tooth-tip width of machining teeth of the chamfering cutter; Zg represents a tooth number of the workpiece gear; and A represents a chamfering amount. Accordingly, interference of the tooth of the chamfering cutter against the workpiece gear can be more securely avoided.

Third feature: the tooth face of the chamfering cutter is an involute surface having no edge as a cutting edge. Accordingly, the chamfering cutter can be easily produced.

Fourth feature: the axis-crossing angle ψ is preferably in a range of 5° to 8°, whereby appropriate strength of the tooth and machining performance can be obtained.

Fifth feature: a gear machining apparatus according to another aspect of the invention includes: a workpiece support that pivotally supports a workpiece gear; and a first machining unit and a second machining unit that move relative to the workpiece support to sequentially machine the workpiece gear, the first machining unit including a cutter support that pivotally supports the chamfering cutter so that the chamfering cutter meshes with the workpiece gear attached to the workpiece support, the cutter support being angled so that the chamfering cutter meshes with the workpiece gear at an axis-crossing angle ψ (ψ≠0) and teeth of the chamfering cutter do not interfere with a tooth face of the workpiece gear, the second machining unit including a shaving cutter that machines the tooth face of the workpiece gear.

Accordingly, the chamfering process by the chamfering cutter of the first machining unit and the tooth-face-machining by the shaving cutter of the second machining unit can be conducted within a single gear machining apparatus, which enhances production efficiency. Further, since the chamfering cutter meshes with the workpiece gear at the axis-crossing angle ψ, the chamfering cutter chamfers the end edge of the workpiece gear by collapsing while restraining the formation of swollen portions generated by excess material produced by the collapsing.

Sixth feature: the gear machining apparatus according to the above aspect may preferably include a third machining unit that is moved relative to the workpiece support to machine the workpiece gear after the second machining unit machines the workpiece gear, the third machining unit including a shaving cutter that machines the tooth face of the workpiece gear, the workpiece support including at least three workpiece supports corresponding to the first machining unit, the second machining unit and the third machining unit, the workpiece gear including three workpiece gears, the first machining unit, the second machining unit and the third machining unit simultaneously machining the three workpiece gears.

In general, the shaving process requires more time than the chamfering process by the chamfering cutter. However, since the shaving process is separately conducted by the second machining unit and the third machining unit, the time difference from the chamfering by the first machining unit can be lessened, thus reducing extra wait time after the first machining.

Seventh feature: the workpiece support is preferably provided on a rotary base, orientation of which is adjustable relative to the first machining unit. Appropriate axis-crossing angle ψ suitable for the workpiece gear can be set by providing the rotary base.

Eighth feature: the workpiece gear may be a helical gear.

Ninth feature: the workpiece gear may be a gear for a vehicle gearbox. The gear machined by the gear machining apparatus of the present invention is highly accurate, excellent in silence and durability and therefore is suitable for a vehicle gearbox.

Tenth feature: the chamfering cutter and the shaving cutter are preferably provided on a turret mechanism and are preferably moved in accordance with a rotation of the turret mechanism to sequentially face the workpiece support to process the workpiece gear. With the use of the turret mechanism, both of the chamfering process by the chamfering cutter and tooth-face-machining by the shaving cutter can be conducted with a single gear machining apparatus, which enhances production efficiency.

Eleventh feature: the workpiece support is preferably provided beneath the turret mechanism and the turret mechanism is preferably lowered to mesh the chamfering cutter and the shaving cutter with the workpiece gear. Thus, the self weight of the turret mechanism can be utilized for meshing and pressing the tool against the workpiece gear.

Twelfth feature: the rotary axis of the turret mechanism is preferably angled (non-parallel) relative to an axis of the workpiece support. In other words, since both of the chamfering cutter and the shaving cutter mesh with the workpiece gear at an axis-crossing angle, the turret mechanism itself can be obliquely positioned, thus simplifying the structure of the apparatus.

Thirteenth feature: the gear machining apparatus according to the above aspect of the invention may further include a third machining unit provided independent of the turret mechanism, the third machining unit being moved relative to the workpiece support to machine the workpiece gear after the second machining unit machines the workpiece gear, in which the third machining unit comprises a shaving cutter that machines the tooth face of the workpiece gear, and the workpiece support includes at least two workpiece supports corresponding to the turret mechanism and the third machining unit, the workpiece gear including two workpiece gears, the turret mechanism and the third machining unit simultaneously machining the two workpiece gears.

In general, the shaving process requires more time than the chamfering process by the chamfering cutter. However, since the shaving process is separately conducted by the second machining unit of the turret mechanism and the third machining unit provided on other than the turret mechanism, the time difference from the chamfering by the first machining unit can be lessened, thus reducing extra wait time after the first machining.

Fourteenth feature: the gear machining apparatus according to the above aspect of the invention may further include: a third machining unit that is moved relative to the workpiece support to machine the workpiece gear after the second machining unit machines the workpiece gear, in which the third machining unit comprises a shaving cutter that machines the tooth face of the workpiece gear, and the chamfering cutter of the first machining unit, the shaving cutter of the second machining unit and the shaving cutter of the third machining unit are respectively provided on the turret mechanism. With the use of the turret mechanism, both of the chamfering process by the chamfering cutter and tooth-face-machining by the shaving cutter can be conducted with a single gear machining apparatus, which enhances production efficiency. Further, since the shaving process is separately conducted by the second machining unit and the third machining unit, appropriate tool can be selectively used for the second machining unit (for rough finishing, for instance) and the third machining unit (for precise finishing, for instance).

Fifteenth feature: the workpiece support is preferably not provided with a rotary drive source of the workpiece gear and the workpiece gear meshes with the chamfering cutter to follow the rotation thereof. Accordingly, the number of the rotary drive source can be reduced and structure can be simplified. In addition, since the workpiece gear follows the rotation of a composite cutter, inertia of which is relatively large, acceleration/deceleration time can be reduced.

Sixteenth feature: the gear machining apparatus according to the above aspect preferably further includes: a roller cutter unit that brings two roller cutters into contact with the workpiece gear in a direction different from the cutter support to remove burrs on the workpiece gear. Accordingly, the chamfering and burr-removing can be simultaneously conducted, thereby reducing the machining time.

A gear machining method of the present invention includes the following features.

Seventeenth feature: a gear machining method according to still another aspect of the invention includes: a chamfering step for chamfering an end edge of a workpiece gear by rotating a chamfering cutter after meshing with the workpiece gear at an axis-crossing angle ψ; a thermally treating step for heating the workpiece gear after the chamfering step without providing a tooth face; and at least one tooth-face-finishing step for shaping the tooth face of the workpiece gear after the thermally treating step.

Since the chamfering cutter meshes with the workpiece gear at the axis-crossing angle ψ, the chamfering cutter chamfers the end edge of the workpiece gear by collapsing while restraining the formation of swollen portions generated by excess material produced by the collapsing. Further, when a thermal treatment is conducted after the chamfering step without shaping a tooth face, the number of the steps can be reduced, thereby enhancing production efficiency.

Eighteenth feature: the tooth face of the chamfering cutter is preferably an involute surface having no edge as a cutting edge. Accordingly, the chamfering cutter can be easily produced.

Nineteenth feature: the tooth-face-finishing step can be selected from, for instance, at least one of a finishing-hob process, a gear-grinding process, a honing process and a reaming process.

Twentieth feature: in the above, a workpiece support for pivotally supporting the workpiece gear and a cutter support for pivotally supporting a chamfering cutter are preferably used so that the workpiece gear attached to the workpiece support is meshed with the chamfering cutter, and the cutter support preferably meshes the chamfering cutter with the workpiece gear at an axis-crossing angle ψ.

Twenty-first feature: the workpiece support is preferably provided on a rotary base, orientation of which is adjustable relative to the cutter support. Appropriate axis-crossing angle ψ suitable for the workpiece gear can be set by providing the rotary base.

Twenty-second feature: the workpiece gear is preferably a helical gear.

Twenty-third feature: the workpiece gear is preferably a gear for a vehicle gearbox. The gear machined by the gear machining method of the invention is highly accurate, excellent in silence and durability and therefore is suitable for a vehicle gearbox.

Twenty-fourth feature: a gear machining method according to further aspect of the invention includes a chamfering step for chamfering an end edge of a workpiece gear by rotating a chamfering cutter while meshing with the workpiece gear at an axis-crossing angle ψ; and at least one first tooth-face-finishing step for shaping a tooth face of the workpiece gear after the chamfering step without subjecting to a thermal treatment.

Since the chamfering cutter meshes with the workpiece gear at the axis-crossing angle ψ, the chamfering cutter chamfers the end edge of the workpiece gear by collapsing while restraining the formation of swollen portions generated by excess material produced by the collapsing.

Further, without conducting the thermal treatment, the above method can be applied for producing a gear which requires relatively not high accuracy. Since the swollen portion is hardly generated at the first tooth-face-finishing step conducted after the chamfering step, the load applied on a tool used for the first tooth-face-finishing step is relatively low and the lifetime of the tool can be prolonged. Accordingly, the frequency for stopping the machining tools for tool exchanging work and maintenance/check frequency can be reduced and tool cost can be reduced.

Since no thermal treatment is conducted at the time of the first tooth-face-finishing step, the workpiece gear can be easily machined.

Twenty-fifth feature: the first tooth-face-finishing step is preferably a shaving process.

Twenty-sixth feature: the gear machining method may further include a thermally treating step for heating the workpiece gear after the first tooth-face-finishing step. Since the hardness of the workpiece gear can be increased by the thermally treating step, the produced gear can be suitably used, for instance, for a highly precise gear of a vehicle gearbox that requires high output, silence and durability.

Twenty-seventh feature: the gear machining method according to the above aspect further includes at least one second tooth-face-finishing step for shaping the tooth face of the workpiece gear after the thermally treating step. Accurate machining can be conducted by separately conducting the tooth-face-finishing step before and after the thermal treatment. The second tooth-face-finishing step increases the accuracy of the workpiece gear, which is further suitably used as a highly precise gear for a vehicle gearbox that requires high output, superior silence and durability.

Twenty-eighth feature: the second tooth-face-finishing step can be, for instance, selected from at least one of a finishing-hob process, a gear-grinding process, a honing process and a reaming process.

Twenty-ninth feature: in the above, a gear machining apparatus including a workpiece support that pivotally supports the workpiece gear and a first machining unit and a second machining unit that move relative to the workpiece support to sequentially machine the workpiece gear is preferably used, the chamfering step is preferably conducted by the first machining unit and the first tooth-face-finishing step is preferably conducted by the second machining unit.

Thirtieth feature: in the gear machining method according to the above aspect, the gear machining apparatus preferably comprises a third machining unit that moves relative to the workpiece support to machine the workpiece gear after the machining by the second machining unit, the third machining unit comprises a shaving cutter that machines the tooth face of the workpiece gear, and the workpiece support includes at least three workpiece supports corresponding to the first machining unit, the second machining unit and the third machining unit, the workpiece gear including three workpiece gears, the first machining unit, the second machining unit and the third machining unit simultaneously machining the three workpiece gears.

In general, the shaving process requires more time than the chamfering process by the chamfering cutter. However, since the shaving process is separately conducted by the second machining unit and the third machining unit, the time difference from the chamfering by the first machining unit can be lessened, thus reducing extra wait time after the first machining.

Thirty-first feature: the first machining unit and the second machining unit are preferably provided on a turret mechanism, the first machining unit and the second machining unit being sequentially moved to a position facing the workpiece support in accordance with a rotation of the turret mechanism to machine the workpiece gear. With the use of the turret mechanism, both of the chamfering process by the chamfering cutter and tooth-face-machining by the shaving cutter can be conducted with a single gear machining apparatus, which enhances production efficiency.

Thirty-second feature: the rotary axis of the turret mechanism is preferably angled relative to an axis of the workpiece support at an axis-crossing angle ψ. In other words, since both of the chamfering cutter and the shaving cutter mesh with the workpiece gear at an axis-crossing angle, the turret mechanism itself can be obliquely positioned, thus simplifying the structure of the apparatus.

Thirty-third feature: in the gear machining method according to the above aspect of the invention, a third machining unit independent of the turret mechanism is preferably provided, the third machining unit being moved relative to the workpiece support to machine the workpiece gear after the second machining unit machines the workpiece gear, in which the third machining unit comprises a shaving cutter that machines the tooth face of the workpiece gear, and the workpiece support includes at least two workpiece supports corresponding to the turret mechanism and the third machining unit, the workpiece gear including two workpiece gears, the turret mechanism and the third machining unit simultaneously machining the two workpiece gears.

In general, the shaving process requires more time than the chamfering process by the chamfering cutter. However, since the shaving process is separately conducted by the second machining unit of the turret mechanism and the third machining unit provided on other than the turret mechanism, the time difference from the chamfering by the first machining unit can be lessened, thus reducing extra wait time after the first machining.

Thirty-fourth feature: in the gear machining method according to the above aspect of the invention, a third machining unit that is moved relative to the workpiece support to machine the workpiece gear after the second machining unit machines the workpiece gear is preferably provided, in which the third machining unit comprises a shaving cutter that machines the tooth face of the workpiece gear; and the chamfering cutter of the first machining unit, the shaving cutter of the second machining unit and the shaving cutter of the third machining unit are respectively provided on the turret mechanism.

With the use of the turret mechanism, both of the chamfering process by the chamfering cutter and tooth-face-machining by the shaving cutter can be conducted with a single gear machining apparatus, which enhances production efficiency. Further, since the shaving process is separately conducted by the second machining unit and the third machining unit, appropriate tool can be selectively used for the second machining unit (for rough finishing, for instance) and the third machining unit (for precise finishing, for instance).

The above and other objects features and advantages of the present invention will become more apparent from the following description when taken in conjunction with the accompanying drawings in which a preferred embodiment of the present invention is shown by way of illustrative example.

### BRIEF DESCRIPTION OF DRAWINGS

FIG. 1 is a schematic perspective view showing a machining section of a gear machining apparatus;

FIG. 2 is a perspective view showing a workpiece gear;

FIG. 3 is a perspective view showing a chamfering cutter;

FIG. 4 is an enlarged perspective view showing a meshing portion between the chamfering cutter and the workpiece gear;

FIG. 5 is a schematic illustration of the workpiece gear and the chamfering cutter respectively extended along the circumference thereof;

FIG. 6 is a schematic illustration of a workpiece gear and a chamfering cutter according to a meshing condition of a conventional art respectively extended along the circumference thereof;

FIG. 7A is a schematic perspective view showing a meshing portion at an initial meshing stage;

FIG. 7B is a schematic perspective view showing the meshing portion at a medium meshing stage;

FIG. 7C is a schematic perspective view showing the meshing portion at a terminal meshing stage;

FIG. 8 is a schematic perspective view showing a right tooth face after being machined;

FIG. 9A is an illustration showing a movement locus of the chamfering cutter at the end edge when an axis-crossing angle is 5°;

FIG. 9B is an illustration showing a movement locus of the chamfering cutter at the end edge when an axis-crossing angle is 8°;

FIG. 10 is a schematic perspective view showing a left tooth face after being machined;

FIG. 11 is a partially-enlarged schematic illustration showing the workpiece gear and the chamfering cutter extended along the circumference thereof;

FIG. 12 is an enlarged side elevation showing the meshing portion between the chamfering cutter and the workpiece gear;

FIG. 13 is an enlarged view of the end edge of the workpiece gear after being machined with axis-crossing angle of 0°;

FIG. 14 is an enlarged view of the end edge of the workpiece gear after being machined with axis-crossing angle of 5°;

FIG. 15 is an enlarged view of the end edge of the workpiece gear after being machined with axis-crossing angle of 8°;

FIG. 16 is an enlarged view showing the end edge of the two-thousandth workpiece gear after being machined for two-thousandth times with axis-crossing angle of 5°;

FIG. 17 is a schematic illustration showing a relationship between teeth of the chamfering cutter and the axis-crossing angle, a cutter tip width, interference, gap and cutter margin width;

FIG. 18A is an illustration showing a movement locus of a tooth face of the chamfering cutter at the end edge when the axis-crossing angle is 4°;

FIG. 18B is an illustration showing the movement locus of the tooth face of the chamfering cutter at the end edge when the axis-crossing angle is 5°;

FIG. 18C is an illustration showing the movement locus of the tooth face of the chamfering cutter at the end edge when the axis-crossing angle is 6°;

FIG. 19 is a plan view showing a gear machining apparatus according to a first example;

FIG. 20 is a perspective view showing a gear machining apparatus according to a second example;

FIG. 21 is a plan view showing a gear machining apparatus according to a third example;

FIG. 22 is a flow chart of a gear machining method according to a first embodiment;

FIG. 23 is a schematic illustration showing a machining condition of a gear-grinding step;

FIG. 24 is a schematic illustration showing a machining condition of a gear-honing step;

FIG. 25 is a flow chart of a gear machining method according to a second embodiment;

FIG. 26 is a flow chart of a gear machining method according to a third embodiment;

FIG. 27 is a flow chart of a gear machining method according to a fourth embodiment;

FIG. 28 is a flow chart of a gear machining method according to a fifth embodiment; and

FIG. 29 is a flow chart of a gear machining method according to a sixth embodiment.

### BEST MODE FOR CARRYING OUT THE INVENTION

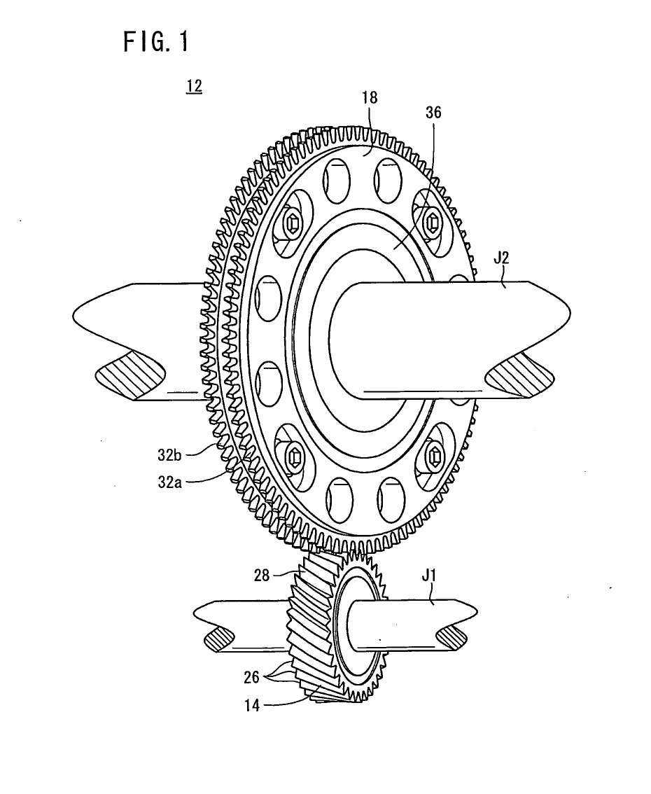

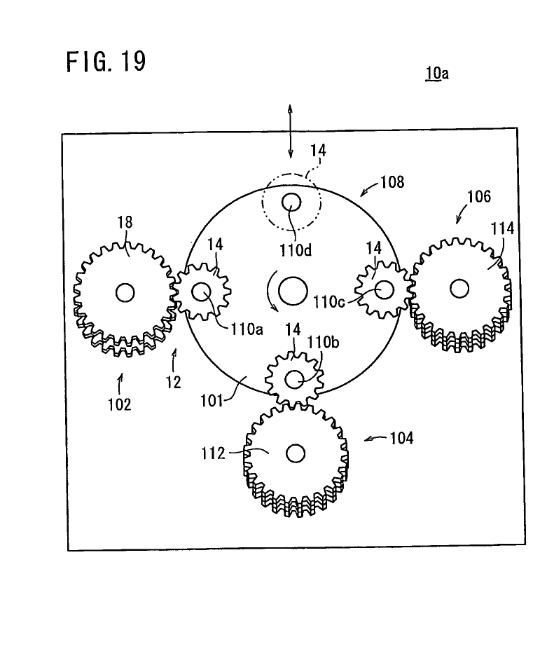

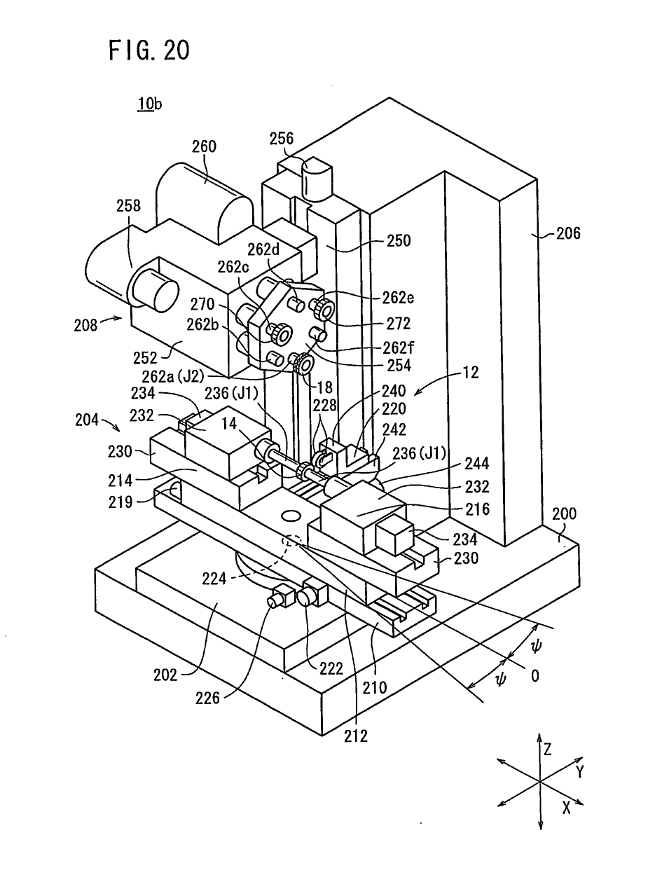

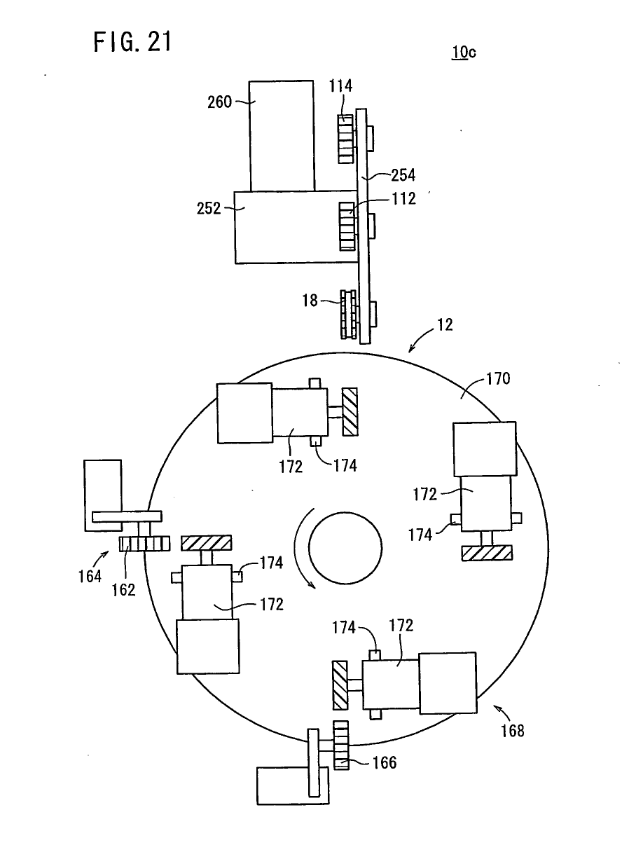

Embodiments of a gear machining method according to the present invention will be described below with reference to attached FIGS. 1 to 29. In the gear machining method of the present embodiments, an end edge of a workpiece gear is at least chamfered after being subjected to rough tooth cutting using a hob. The gear machining method according to the present embodiment is conducted using, for instance, gear machining apparatuses 10a (see FIG. 19), 10b (see FIGS. 20) and 10c (see FIG. 21). With regard to the gear machining apparatuses 10a to 10c, a machining section 12 for machining the workpiece gear with a chamfering cutter will initially be described.

As shown in FIG. 1, the machining section 12 includes: a shaft J1 as a workpiece support for pivotally supporting the workpiece gear 14; and a shaft J2 as a cutter support for pivotally supporting the chamfering cutter 18. The shaft J2 is capable of being rotated by a drive source (not shown). The shaft J1 is rotated in conjunction with a workpiece gear 14 meshed with the chamfering cutter 18.

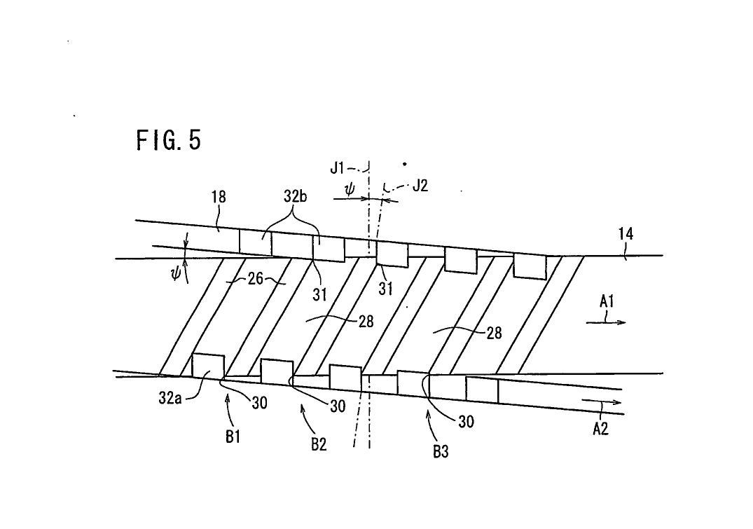

The shaft J2 pivotally supports the chamfering cutter 18 so that the chamfering cutter 18 meshes with the workpiece gear 14 attached to the shaft J1. The shaft J2 is angled so that the chamfering cutter 18 meshes with the workpiece gear 14 at an axis-crossing angle ψ (not 0° and machining teeth 32a, 32b of the chamfering cutter 18 do not interfere with the tooth faces 28 of the teeth 26 of the workpiece gear 14 (see FIG. 5). The axis-crossing angle ψ is an angle formed by the shaft J1 of the workpiece gear 14 and the shaft J2 of the chamfering cutter 18 (see FIG. 5).

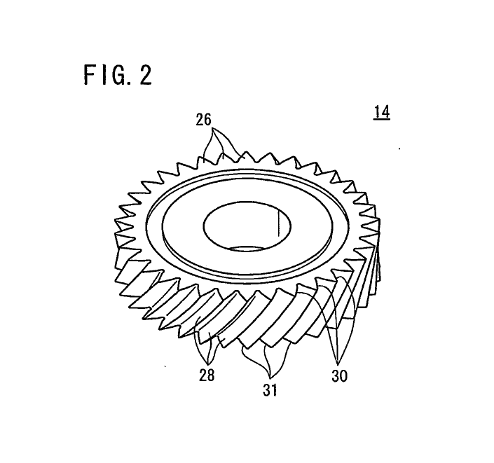

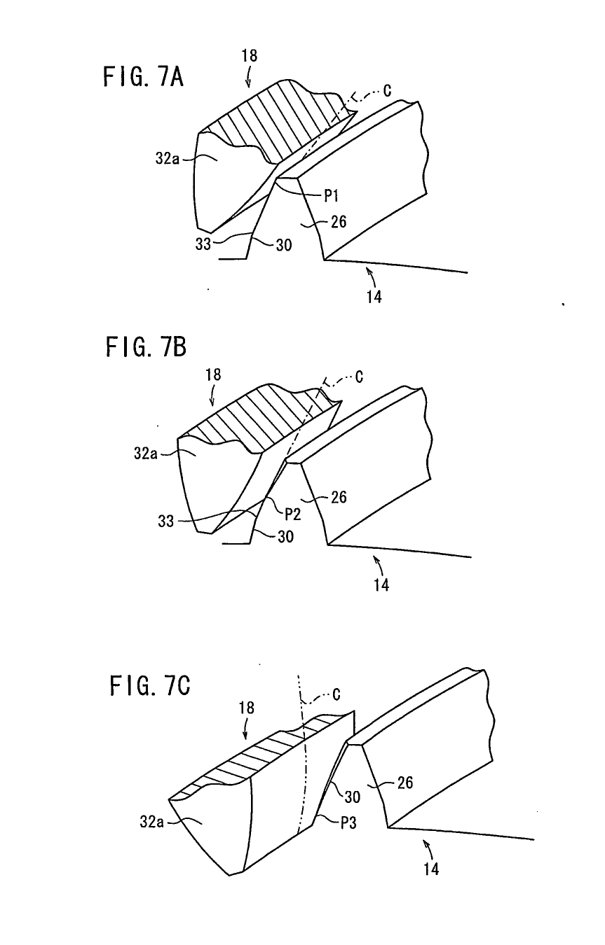

As shown in FIG. 2, the workpiece gear 14 is, for instance, a helical gear, which has an acute portion 33 on the right and left end edges 30 and 31 (see FIG. 7A) after being roughly cut. The machining section 12 chamfers the acute portion 33. The workpiece gear 14 machined by the machining section 12 is not limited to a helical gear but may alternatively be a spur gear and the like. The workpiece gear 14 is used for gearbox of a motor vehicle, for instance. The gear machined by the machining section 12 is highly accurate, superior in silence and durability, which is suitably used for a motor vehicle gearbox.

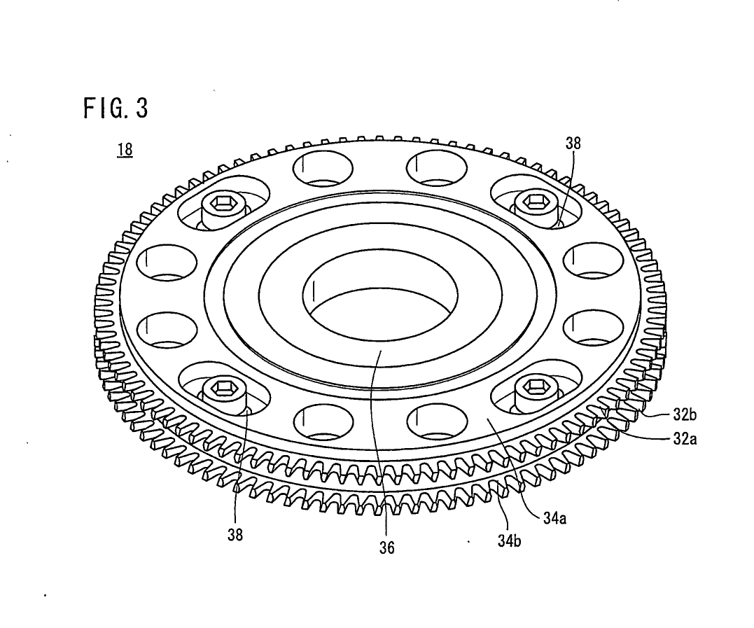

As shown in FIG. 3, the chamfering cutter 18 is provided with a first piece 34a including a set of chamfering machining teeth 32a on one side in thickness direction and a second piece 34b including another set of chamfering machining teeth 32b on the other side. The first piece 34a and the second piece 34b are fixed on a boss 36 to provide a so-called three-piece structure. The first piece 34a and the second piece 34b are respectively capable of adjusting an angle relative to the boss 36 using elongated holes 38.

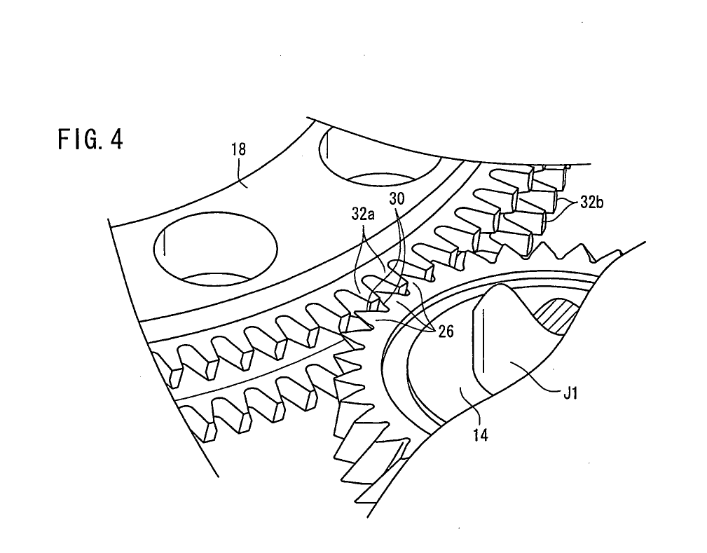

As shown in FIGS. 4 and 5, the machining teeth 32a and the machining teeth 32b are spaced from each other corresponding to the thickness of the workpiece gear 14. The chamfering cutter 18 and the workpiece gear 14 are rotated while being meshed with each other and the machining teeth 32a of a chamfering cutter 18 are pressed onto the end edges 30 to collapse and chamfer the acute portion 33. The machining teeth 32b of a chamfering cutter 18 are pressed onto the other end edges 31 to collapse the acute portion 33 during the chamfering process.

FIG. 5 shows a relative positional relationship between teeth 26 of the workpiece gear 14 and the machining teeth 32a, 32b of the chamfering cutter 18, with a schematic illustration of the workpiece gear 14 and the chamfering cutter 18 respectively extended along the circumference thereof. As can be recognized from FIG. 5, the workpiece gear 14 and the chamfering cutter 18 are disposed at the axis-crossing angle ψ to be obliquely crossed.

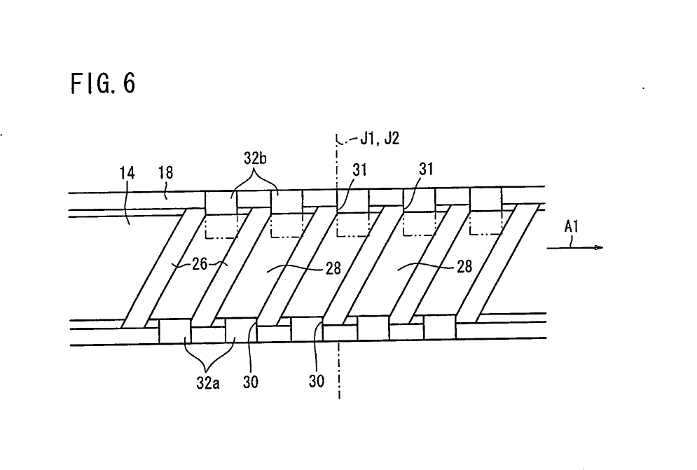

On the other hand, axis-crossing angle is not provided in the meshing of a conventional art as shown in FIG. 6.

Next, how the machining teeth 32a of the chamfering cutter 18 are pressed onto the end edges 31 to collapse the acute portion 33 will be described below.

The workpiece gear 14 is rotated in right direction in FIG. 5, i.e., in a direction of an arrow A1. On the other hand, the chamfering cutter 18 is rotated in an oblique direction by the angle ψ, i.e., in a direction of an arrow A2.

As shown in FIG. 7A, the machining tooth 32a of the chamfering cutter 18 is initially abutted on a portion P1 approximately at the top of the end edge 30 of the tooth 26. At this time (initial meshing stage), the machining tooth 32a is slanted rightward with reference to the tooth 26, so that front side relative to a centerline C is in contact with the portion P1. In this state, the acute portion 33 remains on the end edge 30. The centerline C is identified in FIGS. 7A to 7C on the tooth face of the machining tooth 32a in order to facilitate understanding. The meshing at this time corresponds to a meshing state represented by an arrow B1 in FIG. 5.

As shown in FIG. 7B, at the middle stage of the meshing, the machining tooth 32a of the chamfering cutter 18 is abutted on a portion P2 approximately at the middle of the height of the tooth 26. The machining tooth 32a is approximately parallel to the tooth 26 and the centerline C is abutted on the portion P2 at the middle stage of the meshing. Though a side above the portion P2 is chamfered and the acute portions 33 are removed, the acute portions 33 remain in the area lower than the portion P2. The meshing at this time corresponds to a meshing state represented by an arrow B2 in FIG. 5.

As shown in FIG. 7C, the machining tooth 32a of the chamfering cutter 18 is abutted on a portion P3 approximately at the bottom of the tooth 26 at the termination of the meshing. At the termination of the meshing, the machining tooth 32a is slanted leftward with reference to the tooth 26, so that the deeper section relative to the centerline C is abutted on the portion P3. At this time, the end edge 30 is chamfered on the entire length thereof and the acute portions 33 are removed. The meshing at this time corresponds to a meshing state represented by an arrow B3 in FIG. 5.

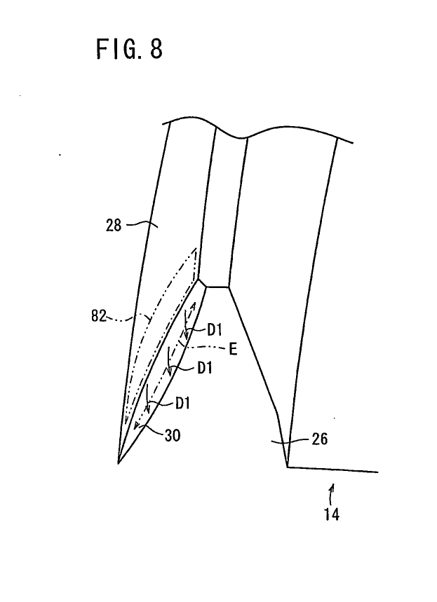

As shown in FIG. 8, a thin planar portion is formed on the chamfered end edge 30 and the acute portions 33 are removed. The locus of the movement of the machining tooth 32a is obliquely directed as shown in arrows D1 including a lateral (tooth thickness direction) movement component.

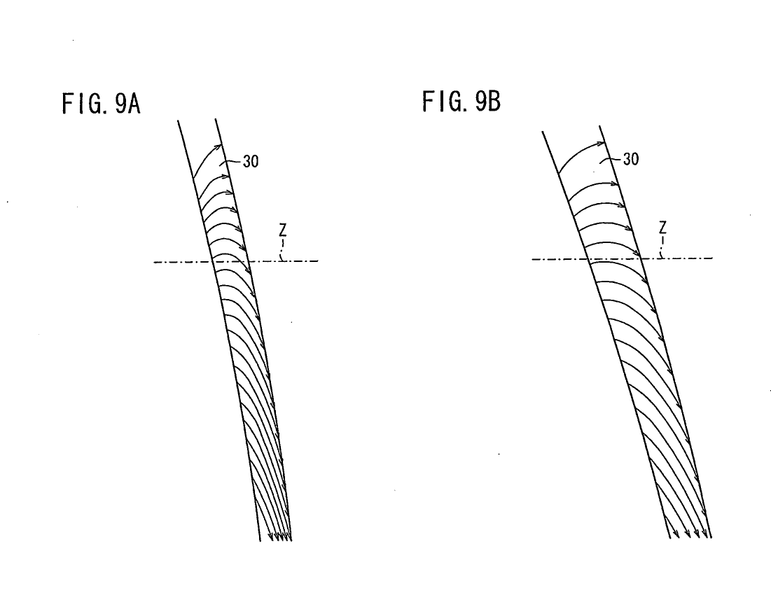

Further detailed movement locus of the tooth face of the chamfering cutter on the end edge 30 is illustrated in FIGS. 9A and 9B. FIG. 9A shows the movement locus when the axis-crossing angle ψ is 5° and FIG. 9B shows the movement locus when the axis-crossing angle ψ is 8°. The code Z represents a meshing circle of the workpiece gear 14 and the chamfering cutter 18. As can be understood by FIGS. 9A and 9B, considerable lateral components are included in the movement locus, which is greater when the axis-crossing angle is 8° than when the axis-crossing angle is 5°. Cutting performance is usually in proportion to the lateral components.

In contrast, since the meshing according to the conventional art has no axis-crossing angle ψ (i.e., ψ=0°) (see FIG. 6), the locus of the movement of the machining tooth 32a contains no lateral movement components as shown in an arrow E in FIG. 8.

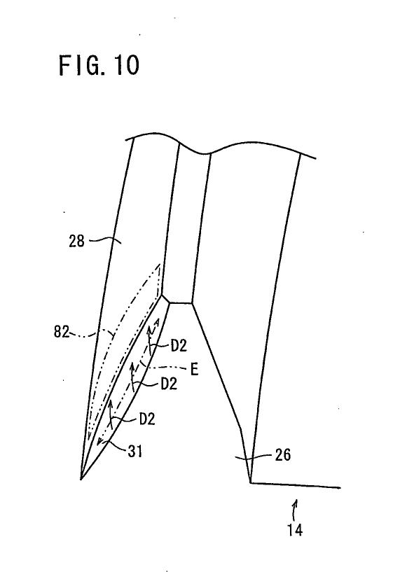

In other words, since the chamfering cutter 18 meshes with the workpiece gear 14 with the axis-crossing angle ψ, the machining section 12 of the gear machining apparatus not only collapses and chamfers the acute portion 33 on the end edge 30 of the workpiece gear 14 but also causes surface-to-surface slide movement including the lateral movement components. Accordingly, generation of swollen excess material at a portion 82 adjacent to the chamfered portion on the tooth face 28 (see FIGS. 8 and 10) can be prevented or restrained.

Further, the tooth faces of the machining teeth 32a of the chamfering cutter 18 are designed to be pressed onto and slid against the end edge 30. Accordingly, the tooth faces of the chamfering cutter 18 are involute surfaces having no edges, which can be easily manufactured.

Incidentally, though detailed explanation is omitted, end edges 31 on the opposite side of the workpiece gear 14 are suitably chamfered by the machining teeth 32b of the chamfering cutter 18, so that the generation of swollen excess material at a portion 82 adjacent to the chamfered portion (see FIG. 10) can be prevented or restrained. In this case, the movement locus of the machining teeth 32b is obliquely directed as shown in an arrow D2 in FIG. 10 including lateral movement component and the same effects as the machining on the end edges 30 can be obtained. More specifically, the locus of the movement is directed reverse to the arrows shown in FIGS. 9A and 9B.

Incidentally, the axis-crossing angle ψ is not typically provided in the meshing according to the conventional art (see FIG. 6). This is because the swollen portion by the excess material generated at the portion 82 (see FIG. 8) adjacent to the chamfered portion has been overlooked, or because the effectiveness of provision of the axis-crossing angle ψ for solving the problem has not been recognized.

Though the axis-crossing angle ψ is provided in the device disclosed in Japanese Laid-Open Patent Publication No. 61-284318, it is practically not easy to chamfer the end edges 30 and 31 by serrations.

Further, since provision of the axis-crossing angle ψ sometimes results in interference of the machining teeth 32a, 32b of the chamfering cutter 18 with the tooth face 28 of the tooth 26 of the workpiece gear 14 (see imaginary line in FIG. 6), it is difficult to set the axis-crossing angle ψ, resulting in the absence of the axis-crossing angle.

The inventors of the present invention have found the following formula (1) in order to appropriately set the axis-crossing angle ψ.

$$\begin{matrix}( \frac{D B G \times π}{Zg} - S B G ) + A \times tan ( B O G ) - {1}_{2} \times tan ( B O G ) - α \\ ≧ S K C \times cos ( ψ ) \\ cos ( Ψ ) ≦ \frac{( \frac{D B G \times π}{Zg} - S B G ) + A \times tan ( B O G ) - {1}_{2} \times tan ( B O G )}{S K C}\end{matrix} \} \qquad ( 1 )$$

Here, the left side of the upper formula represents the interference of the workpiece gear 14 with the chamfering cutter 18. Accordingly, interference can be avoided by thinning the machining teeth 32a, 32b by the value indicated by the left side of the upper formula. The right side represents a cosine component of tip width of the machining teeth 32a, 32b.

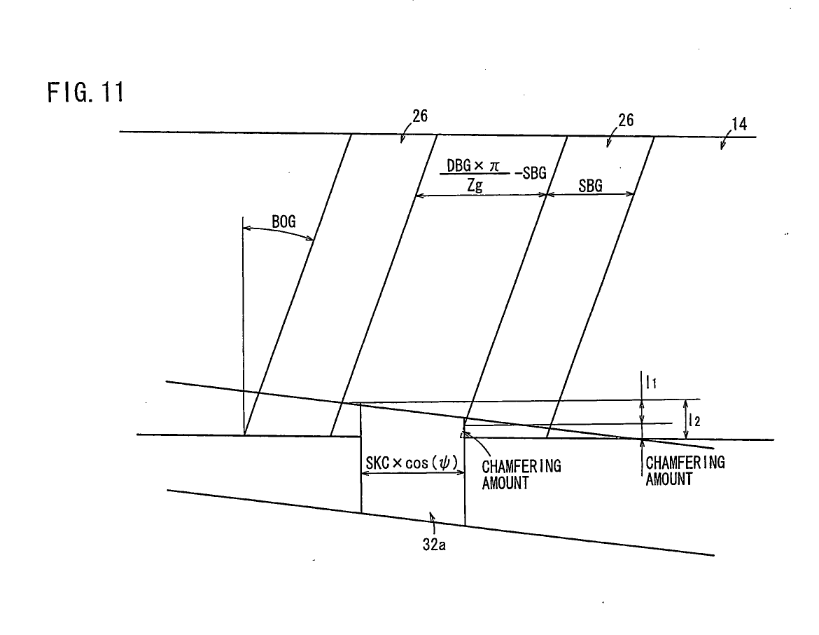

Further, as shown in FIG. 11, l₁ represents a chamfering width, l₂ represents a lap value, BOG represents a gear deflection angle, and SBG represents a circular thickness on a pitch circle. DBG represents a pitch diameter of the workpiece gear 14. A represents a chamfering amount.

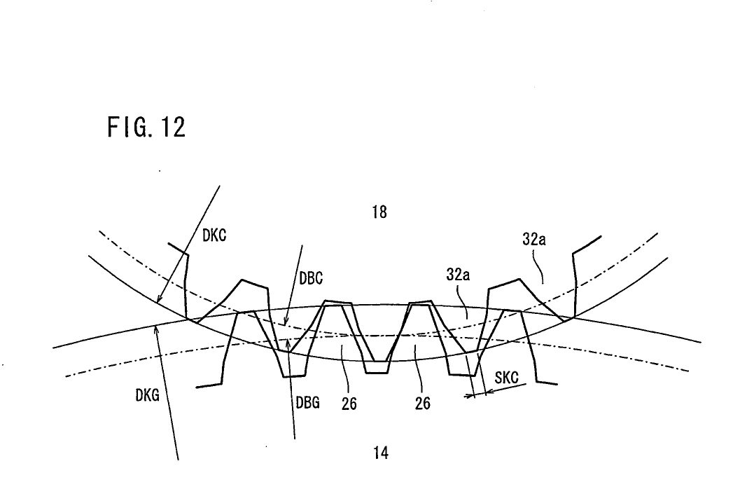

As shown in FIG. 12, DBG represents a pitch circle diameter of the workpiece gear 14, DKG represents an outside diameter of the workpiece gear 14, DBC represents a pitch circle diameter of the chamfering cutter 18 and DKC represents an outside diameter of the chamfering cutter 18. Zg represents a tooth number of the workpiece gear 14 and α represents a margin. SKC represents a tooth-tip width of the machining teeth 32a, 32b of the chamfering cutter 18.

After modifying the above formula (1), the following formula (2) can be obtained.

$$Ψ ≦ {cos}^{- 1} \{ \frac{( \frac{D B G \times π}{Zg} - S B G ) + A \times tan ( B O G ) - {1}_{2} \times tan ( B O G )}{S K C} \} \qquad ( 2 )$$

In other words, by adjusting the axis-crossing angle ψ at the value represented by the formula (2), the interference of the machining teeth 32a, 32b of the chamfering cutter 18 against the workpiece gear 14 can be more securely prevented.

Next, experimental machining result by the machining section 12 of the thus arranged gear machining apparatus will be described below.

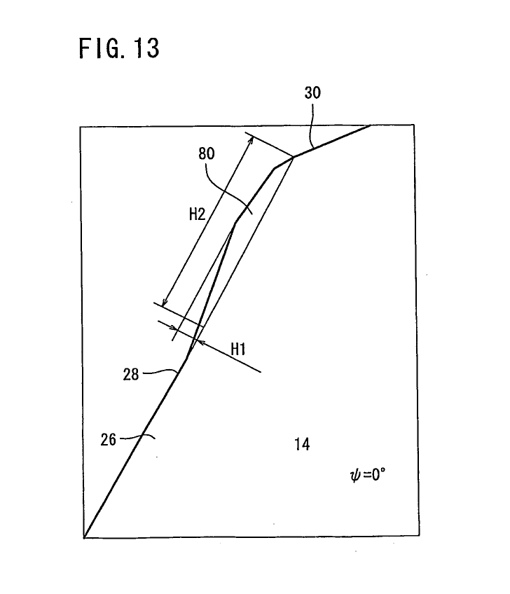

FIG. 13 is an enlarged view showing the end edge 30 (right tooth face) after being chamfered with the axis-crossing angle ψ=0° as in the conventional art. As can be recognized from FIG. 13, a swollen portion 80 by an excess material exists at a portion near the chamfered portion (see portion 82 in FIG. 8). The height of the swollen portion is represented by H1 and width thereof is represented by H2. The results of the right and left tooth faces after being machined at ψ=0° for a predetermined times are shown in the column “ψ=0° ” in Tables 1 and 2. The tooth faces are measured using a contour measuring instrument and the like.

TABLE 1
Height of Swollen Portion H1 (unit: mm)

| | | ψ = 0° | ψ = 5° | ψ = 8° |
|---|---|---|---|---|
| Left Tooth | Average | 0.003 | 0.0002 | 0 |
| Face | Maximum | 0.013 | 0.004 | 0 |
| | Minimum | 0.002 | 0 | 0 |
| Right Tooth | Average | 0.022 | 0.0004 | 0 |
| Face | Maximum | 0.044 | 0.015 | 0 |
| | Minimum | 0.020 | 0 | 0 |

TABLE 2
Height of Swollen Portion H2 (unit: mm)

| | | ψ = 0° | ψ = 5° | ψ = 8° |
|---|---|---|---|---|
| Left Tooth | Maximum | 0.15 | 0.1 | 0 |
| Face | | | | |
| Right Tooth | Maximum | 0.35 | 0.15 | 0 |
| Face | | | | |

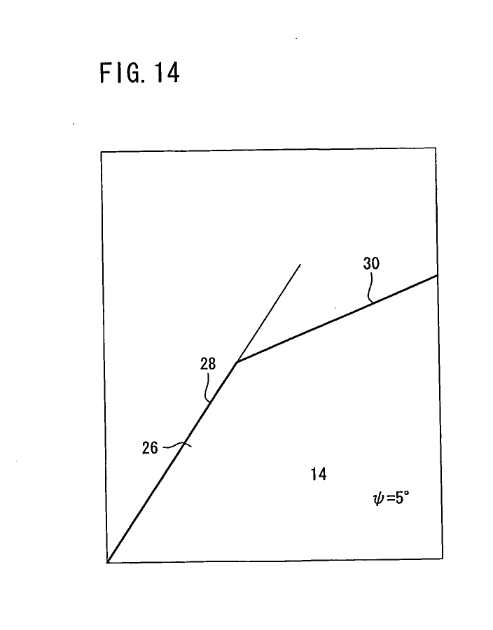

FIG. 14 is an enlarged view showing the end edge 30 (right tooth face) after being chamfered with the axis-crossing angle ψ=5°. As can be recognized from FIG. 14, the formation of the swollen portion 80 is considerably restrained. The results of the right and left tooth faces after being machined at ψ=5° for a predetermined times are shown in Tables 1 and 2 in the column “ψ=5°”.

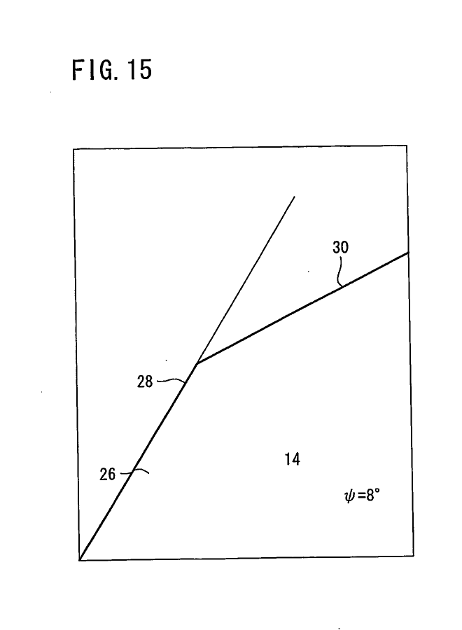

FIG. 15 is an enlarged view showing the end edge 30 (right tooth face) after being chamfered with the axis-crossing angle ψ=8°. As can be recognized from FIG. 15, the swollen portion 80 is hardly generated. The results of the right and left tooth faces after being machined at ψ=8° for a predetermined times are shown in Tables 1 and 2 in the column “ψ=8°”. Incidentally, negative value is represented as “0” in the Tables 1 and 2.

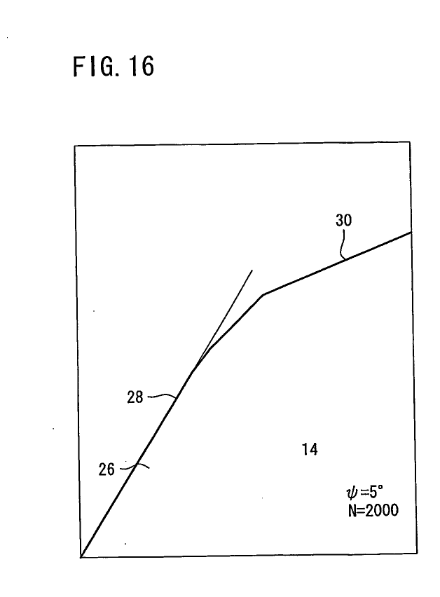

FIG. 16 is an enlarged view showing the end edge 30 (right tooth face) of the two-thousandth workpiece gear after the chamfering process is conducted on two thousand workpiece gears with the axis-crossing angle ψ=5°. As can be understood by comparing FIGS. 14 and 16, there is hardly a change in the swollen portion 80 between the initial gear and the two-thousandth gear. Further, accurate measurement of the profile of the machining teeth 32a and the machining teeth 32b of the chamfering cutter 18 shows that no wear can be recognized after the two-thousandth machining.

As described above, the gear machining apparatus can prevent or considerably restrain the formation of the swollen portion 80. Further, even after a large number of machining, the product accuracy remains stable causing no wear on the chamfering cutter 18, which proves sufficient durability.

Next, the results of analysis on the value of the axis-crossing angle ψ of the machining section 12 of thus arranged gear machining apparatus will be described below.

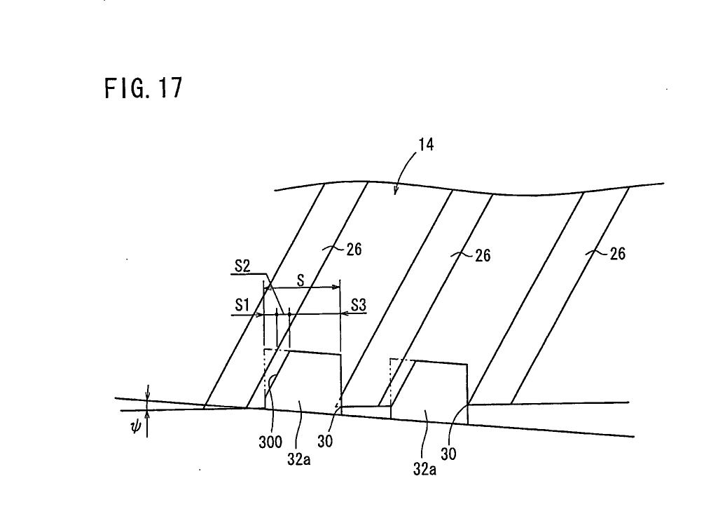

As shown in FIG. 17, when the axis-crossing angle ψ is set large, the machining teeth 32a interfere with the teeth 26 of the workpiece gear 14. Accordingly, escape faces 300 approximately in parallel to the teeth 26 are provided on an end of the rear side of the machining teeth 32a. The escape face 300 allows enlargement of the axis-crossing angle ψ and improvement in machining efficiency. FIG. 17 shows a shape of the machining teeth 32a in which a cutter margin width S3 is secured in view of interference S1 and gap S2 relative to a cutter tip width S considering the interference with the teeth 26 of the workpiece gear 14.

Incidentally, 0.4 mm or more of the cutter margin width S3 is preferably provided in terms of strength. The gap S2 is preferably set approximately at 0.5 mm considering possible presence of error and the like. The results of analyzing and calculating the relationship among the axis-crossing angle ψ, the interference S1, the cutter tip width S and the cutter margin width S3 under a standard condition are shown in Table 3. The gap S2 is set at 0.5 mm.

TABLE 3

| Axis-Crossing | Interference | Cutter Tip | Cutter Margin |
|---|---|---|---|
| Angle ψ | S1 [mm] | Width S [mm] | Width S3 [mm] |
| 4° | 1.14 | 2.18 | 0.54 |
| 5° | 1.18 | 2.19 | 0.51 |
| 6° | 1.23 | 2.20 | 0.47 |
| 7° | 1.28 | 2.21 | 0.43 |
| 8° | 1.31 | 2.23 | 0.42 |
| 9° | 1.36 | 2.24 | 0.38 |

As is clearly shown in the Table 3, when the axis-crossing angle ψ is 8°, the cutter margin width S3 is 0.42 mm, for sufficiently securing the strength. When the axis-crossing angle ψ is 9°, the cutter margin width S3 is 0.38 mm, resulting in strength poverty. In other words, the axis-crossing angle ψ is preferably 8° or less (ψ≦8°) in terms of strength.

When the axis-crossing angle ψ is 4°, the cutter margin width S3 is 0.54 mm and it is considered that sufficient strength can be secured. However, machining efficiency is deteriorated. It is considered that the formation of the swollen portion near the chamfered portion on the workpiece gear 14 can be more effectively restrained as the movement locus of the machining teeth 32a of the chamfering cutter 18 at the end edge 30 is directed more laterally.

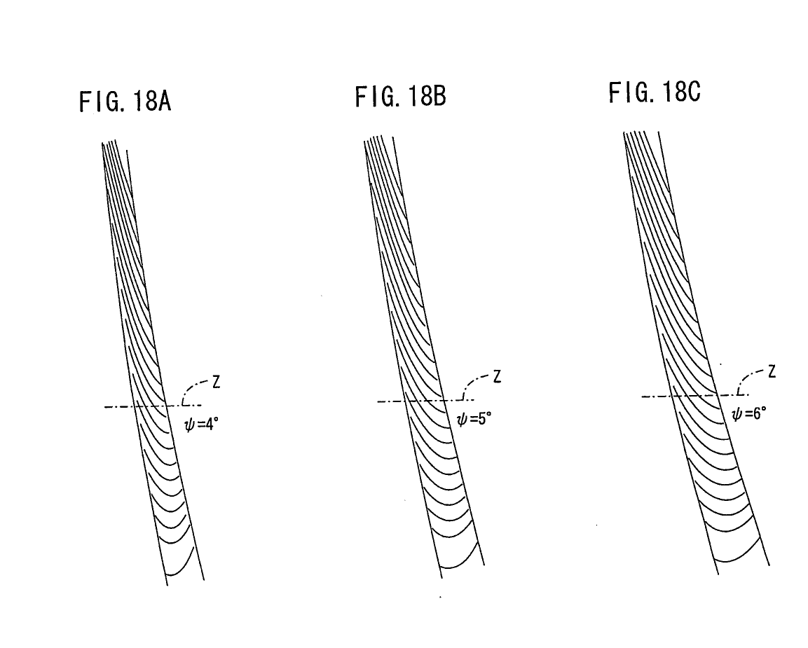

As shown in the simulation results of FIG. 18A, when the axis-crossing angle ψ=4°, the movement locus of the machining teeth 32a shows considerably steep inclination and only a small amount of lateral component is contained, resulting in low restraining effect for the formation of the swollen portion.

On the other hand, as shown in the simulation results of FIG. 18B, when the axis-crossing angle ψ=5°, the movement locus of the machining teeth 32a shows relatively gentle inclination and a certain amount of lateral component is contained, which restrains the formation of the swollen portion.

As shown in the simulation results of FIG. 18C, when the axis-crossing angle ψ=6°, the movement locus of the machining teeth 32a becomes considerably gentle and a large amount of lateral component is contained, which produces high restraining effect for the formation of the swollen portion. In other words, in order to restrain the formation of the swollen portion, it is preferable that the axis-crossing angle ψ is 5° or more (ψ≧5°.

Consequently, in order to satisfy both of the strength of the machining teeth 32a and the machining performance, the axis-crossing angle ψ is preferably in the range of 5° to 8°.

Incidentally, the Japanese Laid-Open Patent Publication No. 61-284318 discloses that the chamfering cutter is meshed with the workpiece gear at a predetermined axis-crossing angle α. The chamfering cutter used in the Japanese Laid-Open Patent Publication No. 61-284318 employs a unique tool arrangement in which the cutter “includes a plurality of serrated edges extending in a direction orthogonal to the gear and parallel with each other, the phase of the serrated edges being slightly shifted sequentially per one edge in a tool-center direction”. Accordingly, “the serrated edges of the respective teeth of the pinion cutter carve the side periphery on the front side in the tool rotary direction of the gear. Since the serrated edges of the respective cutting surface of the tool are slightly shifted sequentially per one edge in a tool-center direction, the abutment portions at which the serrated edges are abutted to the chamfering portion of the respective teeth are slightly shifted, so that the entirety of the chamfering surface can be uniformly carved.

In other words, Japanese Laid-Open Patent Publication No. 61-284318 “carves” the workpiece gear using the chamfering cutter having the serrated edges, and the axis-crossing angle α is provided in order to carve the workpiece gear. Further, it is difficult to provide serrations as cutting edges on a tooth face and short lifetime is expected, which is thus considered not so much practical. In fact, the tool according to Japanese Laid-Open Patent Publication No. 61-284318 has not been made into practical use.

On the other hand, since the machining teeth 32a, 32b of the chamfering cutter 18 have no serrated edges but have basically smooth surface, the chamfering cutter 18 can easily be manufactured, have long lifetime, and be practical. Such gear machining apparatus (see FIG. 20) has already been put into practical use and preferable results have been exhibited.

Next, the gear machining apparatuses 10a, 10b and 10c having the machining section 12 will be described below.

As shown in FIG. 19, the gear machining apparatus 10a according to a first example is for simultaneously conducting chamfering process and shaving process on a plurality of workpiece gears 14. The gear machining apparatus 10a includes: a feed table 101 for intermittently rotating the workpiece gear 14 by 90°; a first stage (first machining unit) 102 for chamfering the workpiece gear 14 by the chamfering cutter 18; a second stage (second machining unit) 104 for conducting a first shaving on the workpiece gear 14; a third stage (third machining unit) 106 for conducting a second shaving on the workpiece gear 14; and a loading/unloading stage 108 for exchanging the workpiece gear 14. The feed table 101 is, for instance, horizontally rotated.

The feed table 101 includes four rotary shafts (workpiece support) 110a, 110b, 110c and 110d capable of pivotally supporting the workpiece gear 14 at equal intervals (90°) near the outer circumference of the feed table 101. The four rotary shafts 110a to 110d may be independently rotated by four motors or, alternatively, may be rotated by a distributed drive force from a single motor. Among the rotary shafts 110a to 110d, the one located at the loading/unloading stage 108 is stopped for loading/unloading the workpiece gear 14, where the motor corresponding to the gear is stopped or a corresponding clutch is disengaged.

The first stage 102 is a stage for chamfering the end edges 30, 31 of the workpiece gear 14 and is provided with the machining section 12 (see FIG. 1). As described above, the machining section 12 is provided with a chamfering cutter 18, which is meshed with the workpiece gear 14 with the axis-crossing angle 1p. The chamfering cutter 18 is capable of radial advancement and retraction relative to the feed table 101. When the chamfering cutter 18 chamfers the workpiece gear 14, the chamfering cutter 18 meshes with the workpiece gear 14. On the other hand, when feed table 101 is rotated, the chamfering cutter 18 is outwardly retracted.

The second stage 104 is a stage for conducting a first machining (i.e., shaving) on a tooth face 28 of the workpiece gear 14, which is provided with a shaving cutter 112. The shaving cutter 112 is capable of radial advancement and retraction relative to the feed table 101. When the workpiece gear 14 is machined, the shaving cutter 112 meshes with the workpiece gear 14. On the other hand, when the feed table 101 is rotated, the shaving cutter 112 is outwardly retracted. The shaving process of the second stage 104 corresponds to rough finishing.

The third stage 106 is a stage for conducting a second machining (i.e., shaving process) of the tooth face 28 of the workpiece gear 14, which is provided with a shaving cutter 114. The shaving cutter 114 is capable of radial advancement and retraction relative to the feed table 101. When the workpiece gear 14 is machined, the shaving cutter 114 meshes with the workpiece gear 14. On the other hand, when the feed table 101 is rotated, the shaving cutter 114 is outwardly retracted. The shaving process of the third stage 106 corresponds to precise finishing. The shaving cutter 114 of the third stage 106 may be identical with the shaving cutter 112 of the second stage 104 or, alternatively, different cutter that is suitable for precise finishing may be used.

The rotary shafts 110a, 110b, 110c and 110d for pivotally supporting the workpiece gear 14 are vertically provided. On the other hand, the respective tools of the first stage 102, the second stage 104 and the third stage 106 are preferably inclined to provide the axis-crossing angle ψ. It is preferable that the angle is adjustably provided.

The workpiece gear 14 after experiencing the processes up to the third stage 106 is sent to the loading/unloading stage 108, and then unloaded from the gear machining apparatus 10a to be sent to the subsequent processing (e.g., thermal treatment).

According to thus arranged gear machining apparatus 10a, the chamfering by the chamfering cutter 18 at the first stage 102 and the finishing of tooth faces by the shaving cutters 112 and 114 at the second stage 104 and the third stage 106 can be conducted in a single apparatus efficiently. Specifically, no inter-apparatus transportation of the workpiece gear 14 between the chamfering and the shaving is required and space can be reduced, since the chamfering and shaving can be conducted with a single apparatus.

Further, since the chamfering cutter 18 meshes with the workpiece gear 14 with the axis-crossing angle ψ, the chamfering cutter 18 not only collapses the end edges 30, 31 of the workpiece gear 14 but also restrains the formation of the swollen portion on account of excess material caused by the collapsing.

The rotary shafts 110a to 110d as the workpiece support are provided corresponding to the first stage 102, the second stage 104, the third stage 106 and the loading/unloading stage 108, so that three workpiece gears 14 can be simultaneously machined by the first stage 102, the second stage 104, the second stage 104 and the third stage 106.

Typical shaving process requires more time than the chamfering by the chamfering cutter 18. However, since the shaving process are divided into two stages, i.e., the second stage 104 and the third stage 106 (or second step to Nth step (N≧4)), the time difference from the chamfering (first step) can be lessened and extra wait time after the first step can be reduced.

Though the gear machining apparatus 10a includes the three processing stages excluding the loading/unloading stage 108, the number of the processing stage for the workpiece gear 14 may be two or more than three. In other words, efficient processing can be achieved by providing at least the first stage 102 and the second stage 104. When more than three processing stages are provided, for instance, the stage for the shaving process may be divided into three stages. Alternatively, a processing stage for hob-cutting may be provided before the first stage 102.

Next, the gear machining apparatus 10b according to a second example will be described below. In the description of the gear machining apparatus 10b, crosswise direction is defined as X-direction, depth direction is defined as Y-direction and height direction is defined as Z-direction.

As shown in FIG. 20, the gear machining apparatus 10b includes: a rotary table (rotary base) 202 provided on a base 200; a workpiece support 204 provided on the rotary table 202; a drive plate 206; and a tool support 208 provided adjacent to the drive plate 206. In FIG. 20, the console, lubricating device, hydraulic source and coolant of the gear machining apparatus 10b are not illustrated.

The workpiece support 204 includes: an X-slide base provided on the rotary table 202; an X-slider 212 that slides in X-direction relative to the X-slide base 210; a head stock 214 and a tail stock 216 that rotatably support the workpiece gear 14 from both sides thereof on the X-slider 212; and a roller cutter unit 220 provided on a remote side in Y-direction to remove a burr on the workpiece gear 14. The X-slider 212 is capable of movement in a longitudinal direction (equals to X-direction when ψ=0; sometimes simply referred to as X-direction hereinafter) of the X-slide base 210 being driven by the X-motor 219.

A base rotating motor 222 is provided on the slide base 210. The slide base 210 is rotated relative to the rotary table 202 within a horizontal plane being driven by the base rotating motor 222. A worm wheel mechanism, for instance, is used for causing the rotation of the slide base 210 relative to the rotary table 202. A sensor (e.g., a rotary encoder) 224 for accurately measuring the rotation of the slide base 210 is provided on the rotary table 202. The position of the slide base 210 can be accurately determined by full-closed feedback based on the signal of the sensor 224. Specifically, the position of the slide base 210 can be accurately controlled since the rotation of the slide base 210 is directly detected by the sensor 224 without relying on an indirect feedback (so-called semi-closed control) based on the rotation of the base rotating motor 222.

A plurality of (e.g., four) clamps 226 for rigidly securing the slide base 210, positioning of which has been completed are provided on the rotary table 202. The clamps 226 (only one of which is shown in FIG. 20) are provided around the rotary table 202 at regular intervals. The rotation of the slide base 210 corresponds to the axis-crossing angle ψ. The slide base 210 is rotatable for, for instance, approximately ±20°. When the rotary angle is 0° (standard condition), the axis of the workpiece gear 14 coincides with X-direction (ψ=0°).

The head stock 214 includes: a sub-slider 230 slidable in X-direction; a shaft support box 232 that is slidable relative to the sub-slider 230 in X-direction; a stock motor 234 for driving the shaft support box 232; and a support shaft 236 for supporting one side of the workpiece gear 14. The support shaft 236 corresponds to the shaft J1. The tail stock 216 is basically symmetrically arranged with the head stock 214, where the same reference numerals as those of the tail stock 216 are attached thereto and detailed explanation is not given. The head stock 214 and the tail stock 216 differ in drive force for moving in X-direction, where the drive force of the head stock 214 is set larger. The head stock 214 determines the position of the workpiece gear 14 in X-direction. The head stock 214 and the tail stock 216 are moved toward and away from each other when the workpiece gear 14 is attached and detached. No drive source for rotating the workpiece gear 14 is provided on the head stock 214 and the tail stock 216.

The roller cutter unit 220 includes: two roller cutters 228 juxtaposed in X-direction; a roller cutter support 240 that rotatably supports the roller cutters 228; a Y-slide base 242; and a Y-motor 244. The Y-motor 244 advances and retracts the roller cutter support 240 relative to the Y-slide base 242 in traverse direction of the X-slide base 210 (which is equal to Y-direction when ψ=0: sometimes simply referred to as Y-direction hereinafter). The gap between the two roller cutters 228 is adjusted to the tooth width of the workpiece gear 14 so that burrs can be removed when the roller cutters 228 are applied on the workpiece gear 14. No drive source for rotating the roller cutters 228 is provided on the roller cutter unit 220. The roller cutter 228 is brought into contact with the workpiece gear 14 to follow the rotation of the workpiece gear 14 to remove the burrs. The roller cutter unit 220 is provided on the slide base 210.

The tool support 208 includes: a Z-slide base 250; a tool support mechanism box 252 that moves up and down in Z-direction relative to the Z-slide base 250; and a turret mechanism 254 that is intermittently rotated relative to the tool support mechanism box 252.

The Z-slide base 250 is provided adjacent to the drive plate 206, which extends in Z-direction to hold the tool support mechanism box 252 in a manner vertically movable along Z-direction. A Z-motor 256 for effecting up-and-down movement of the tool support mechanism box 252 is provided on an upper side of the Z-slide base 250.

The tool support mechanism box 252 includes an index motor 258 for intermittently rotating the turret mechanism 254 by every 60° and a spindle motor 260 and, consequently, weighs considerably. The tool support mechanism box 252 further includes a positioning pin mechanism and a clutch mechanism (both not shown). The turret mechanism 254 can be accurately positioned by virtue of the positioning pin mechanism. The clutch mechanism controls the power transmission to the turret mechanism 254.

The turret mechanism 254 has a hexagonal side elevation, which is rotated by every 60° in Y-Z plane being driven by the index motor 258. A first arm 262a, a second arm 262b, a third arm 262c, a fourth arm 262d, a fifth arm 262e and a sixth arm 262f are provided around each of the tops of the hexagon of the turret mechanism 254, each of the arms being directed in X-direction. Various tools such as the chamfering cutter 18 and the like can be attached to and detached from the arms 262a to 262f.

The turret mechanism 254 is arranged so that the lowermost one of the six arms 262a to 262f comes just above the workpiece gear 14. The six arms 262a to 262f are disposed at regular intervals (60°). The tool provided on one of the arms located at the lower side to face the workpiece gear 14 can be rotated by the spindle motor 260 through a clutch mechanism. A tooth face detecting sensor (not shown) is provided on the turret mechanism 254. The tool can be automatically meshed with the workpiece gear 14 based on the signal of the tooth face detecting sensor.

The first arm (first machining unit) 262a chamfers the workpiece gear 14 using the chamfering cutter 18. Since the support shaft 236 (shaft J1) of the workpiece support 204 forms the axis-crossing angle ψ in accordance with the turning movement of the rotary table 202, the machining section 12 (see FIG. 1) is provided by the first arm 262a and the support shaft 236.

While chamfering with the first arm 262a, the two roller cutters 228 are driven by the Y-motor 244 to be pressed onto both sides of the workpiece gear 14 to remove the burrs on the both sides. In other words, the turret mechanism 254 and the roller cutter unit 220 are moved toward the workpiece gear 14 from different directions (i.e., Z-direction and Y-direction) to simultaneously conduct chamfering and burr-removing, thereby reducing the machining time. After burr-removing, the roller cutters 228 are returned to the original position.

The third arm (second machining unit) 262c conducts the first shaving process on the workpiece gear 14. The fifth arm (third machining unit) 262e conducts the second shaving process on the workpiece gear 14. The second arm 262b, the fourth arm 262d and the sixth arm 262f serve as backups. By thus alternately providing backups, when three tools are used, the turret mechanism 254 can be balanced well. When two tools are used, the tools may preferably be provided at opposed positions and the backups may preferably be provided at the rest of the locations.

A rough-finishing shaving cutter 270 is provided on the third arm 262c. A precise-finishing shaving cutter 272 is provided on the fifth arm 262e.

In accordance with the rotation of the turret mechanism 254, the first arm 262a, the third arm 262c and the fifth arm 262e are sequentially opposed to the workpiece gear 14 on the workpiece support 204 to machine the workpiece gear 14 thereat. In other words, the respective tools of the turret mechanism 254 driven by the Z-motor 256 are capable of moving up and down. Accordingly, when the workpiece gear 14 is to be chamfered, the tools are lowered to mesh with the workpiece gear 14. On the other hand, when the turret mechanism 254 is to be rotated, the tools are lifted to escape.

When the workpiece gear 14 is to be machined, the workpiece gear 14 follows the rotation of the tool of the turret mechanism 254 that is meshed with the workpiece gear 14. Accordingly, no drive source for rotating the workpiece gear 14 is necessary, thereby providing a simple arrangement. Since the size of the respective tools connected to the turret mechanism 254 is relatively large as compared to the workpiece gear 14, the tools' inertia is large, which necessarily requires relatively large-size spindle motor 260. With the use of relatively large spindle motor 260, the acceleration and deceleration time of the workpiece gear 14 via the tools can be shortened. In other words, since the inertia of the workpiece gear 14 is relatively small, the tool easily follows the acceleration and deceleration of the tools, so that the machining time can be shortened.

The gear machining apparatus 10b separately employs hydraulic drive, pneumatic drive and electric drive in accordance with the to-be-driven sections. The shafts of the X-motor 219, the base-rotating motor 222, the Y-motor 244 and the Z-motor 256 are precisely positioned by an NC control.

When the workpiece gear 14 is machined, the weight of the tool support mechanism box 252 and the turret mechanism 254 is applied on the workpiece gear 14. The workpiece support mechanism box 252 and the turret mechanism 254 have considerable weight. Accordingly, even when the Z-motor 256 does not generate excessively large force (for instance, when the current applied to the Z-motor 256 is 0), sufficient load can be efficiently applied on the workpiece gear 14. Thus, the workpiece gear 14 can be machined while appropriately being pressed, which prevents shifting or de-centering of the workpiece gear 14 during machining, thereby achieving stable processing.

According to thus configured gear machining apparatus 10b, the workpiece gear can be chamfered with the first arm 262a by the chamfering cutter 18 and tooth face can be machined with the third arm 262c and the fifth arm 262e by the shaving cutters 270 and 272, thereby achieving efficient machining with a single apparatus. Further, since the chamfering cutter 18 meshes with the workpiece gear 14 with the axis-crossing angle ψ, the chamfering cutter 18 not only collapses the end edges 30, 31 of the workpiece gear 14 but also restrains the formation of the swollen portion on account of the excess material caused by the collapsing.

Further, since the workpiece support 204 is provided on the rotary table 202 for direction-adjusting relative to the respective arms 262a to 262f, appropriate axis-crossing angle ψ can be set corresponding to the workpiece gear 14.

The respective arms 262a to 262f of the turret mechanism 254 forms the axis-crossing angle ψ against the shaft J2 of the workpiece support 204. In other words, the turret mechanism 254 itself is obliquely situated relative to the shaft J2, all of the chamfering cutter 18 and the shaving cutters 270, 272 are meshed with the workpiece gear 14 with the axis-crossing angle ψ, so that independent angle adjustment becomes not necessary with a simple structure.

The turret mechanism 254 can perform the chamfering by the chamfering cutter 18 and the machining on the tooth face by the shaving cutters 270, 272 with the single gear machining apparatus 10b, thereby achieving efficient machining. Further, since the shaving process are separately conducted by the third arm 262c and the fifth arm 262e, the second machining unit with the third arm 262c can be used for rough finishing and the third machining unit with the fifth arm 262e can be used for precise-finishing, where an appropriate tool can be selectively used.

The gear machining apparatus 10b can provide various tooth faces on the workpiece gear 14 with simultaneous cooperative operation of the X-motor 219 and the Z-motor 256.

As the gear machining apparatus 10c shown in FIG. 21 according to a third example, a third machining unit 164 having a shaving cutter 162 or a fourth machining unit 168 having a shaving cutter 166 may be provided in addition to the turret mechanism 254. In other words, a plurality of workpiece supports 172 may be moved by a table 170 similar to the feed table 101 and the workpiece gear 14 may be sequentially machined by the turret mechanism 254, the third machining unit 164 and the fourth machining unit 168. The workpiece support 172 may be arranged to allow adjustment of the axis-crossing angle ψ in accordance with the rotation of a tilt mechanism 174 provided on the table 170.

According to the gear machining apparatus 10c, a plurality of the workpiece gears 14 can be simultaneously machined by the turret mechanism 254, the third machining unit 164 and the fourth machining unit 168. The turret mechanism 254 corresponds to the first stage, where the chamfering by a first arm 154a and a rough-shaving by a second arm 154b are conducted. Since the finishing shaving by the third arm 154c of the above-described gear machining apparatus 10b is conducted by the third machining unit 164 and/or the fourth machining unit 168, the time-consuming shaving process can be divided into a plurality of stages, so that time difference from the chamfering in the first stage can be lessened and extra wait time after the first stage can be diminished.

Next, gear machining method of the present embodiment will be described below.

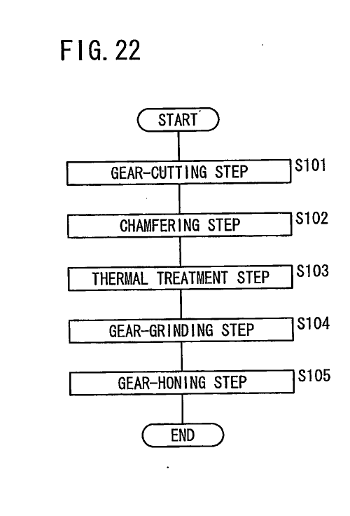

As shown in FIG. 22, in the gear machining method according to the first embodiment, gear-cutting by a hob and the like is conducted on a gear blank in a step S101. The gear-cutting forms an outline of the tooth 26 of the workpiece gear 14, which corresponds to rough finishing of tooth face.

In a step S102 (chamfering), chamfering of the workpiece gear 14 by the machining section 12 is conducted. As described above, the chamfering cutter 18 chamfers the workpiece gear 14 with the axis-crossing angle ψ. Accordingly, the end edges 30, 31 of the workpiece gear 14 are not only collapsed and chamfered but also the formation of the swollen portions of extra material produced by the collapsing can be restrained in the machining section 12. The step 5102 is conducted by, for instance, with the use of the gear machining apparatuses 10a to 10c. However, the process advances to the subsequent step S103 without conducting the tooth-face-shaping processing such as shaving.

In the step S103 (thermal treatment), the workpiece gear 14 is carburized and hardened by thermally treating the workpiece gear 14. Thus, the hardness of the workpiece gear 14 is increased.

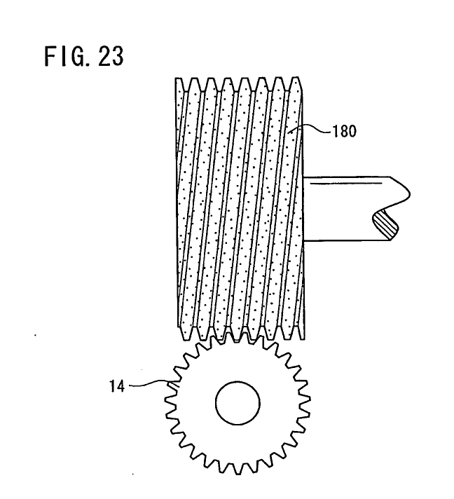

In a step S104 (tooth face finishing), gear-grinding (gear-grinding process) of the workpiece gear 14 is conducted. As shown in FIG. 23, the gear-grinding is a process for meshing a grinding stone 180 having spiral tread with the workpiece gear 14 causing synchronous rotation to finish the tooth face of the tooth 26. At this time, though the workpiece gear 14 is considerably hardened on account of the thermal treatment, since the workpiece gear 14 is chamfered in the chamfering process while restraining the formation of the swollen portion, excessive load is not applied on the grinding stone.

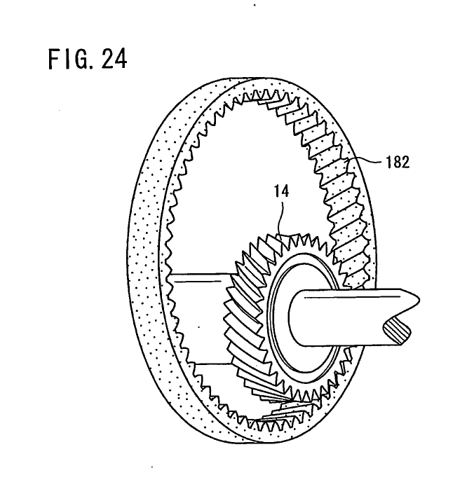

In a step S105 (tooth-face-finishing step), gear-honing (honing step) of the workpiece gear 14 is conducted. As shown in FIG. 24, the gear-honing is conducted by rotating the workpiece gear 14 while meshing with an internal-tooth grinding stone 182 to further precisely finish the tooth face of the teeth 26.

As described above, the number of processes is reduced in the gear machining method according to the first embodiment by conducting thermal treatment after the chamfering process without tooth face shaping for efficient machining.

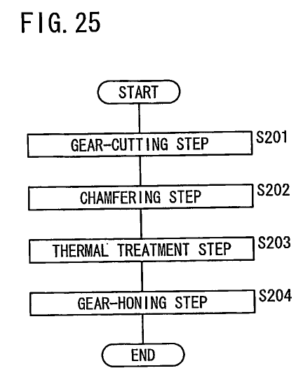

As shown in FIG. 25, the gear machining method according to a second embodiment comprises a gear-cutting step (step S201), a chamfering step (step S202), a thermal treatment step (step S203) and a gear-honing step (step S204) conducted in this order. These steps correspond to the steps S101, S102, S103 and S105 of the gear machining method according to the first embodiment of FIG. 22, where a gear-grinding step (step S104) is omitted.

When the gear-grinding process is omitted as in the above, the load applied to the internal-tooth grinding stone 182 during the gear-honing process in the step S204 is negligibly small in practical use. This is because, though the hardness of the thermally-treated workpiece gear 14 is increased, the formation of the swollen portion 80 (see FIG. 14) is restrained. If a large swollen portion 80 exists, since the swollen portion constantly touches the same portion of the internal-tooth grinding stone 182, which locally worn extremely, and therefore is not suitable for practical use. Since the formation of the swollen portion 80 is restrained in the present embodiment, local application of excessive load on the predetermined portion of the internal-tooth grinding stone 182 can be restrained.

When the gear-grinding process is skipped, the number of the processes is further reduced for efficient machining.

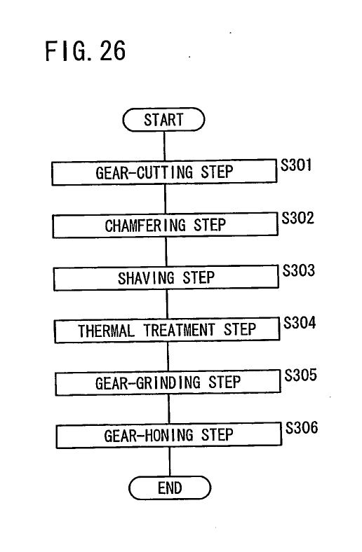

As shown in FIG. 26, the gear machining method according to a third embodiment includes a gear cutting step (step S301), a chamfering step (step S302), a shaving step (step S303, a first tooth-face-finishing step), a thermal treatment step (step S304), a gear-grinding step (step S305, second tooth-face-finishing step) and a gear-honing step (step S306, second tooth-face-finishing step) conducted in this order. In the above, the steps S301, S302, S304; S305 and S306 correspond to the steps S101 to S105 of the gear machining method according to the first embodiment shown in FIG. 22, and the shaving process (step S303) is added.

The steps S302 and S304 are conducted, for instance, using the gear machining apparatuses 10a to 10c. Accordingly, the processes before the thermal treatment can be efficiently conducted in a single apparatus, where no inter-apparatus transportation of the workpiece gear 14 is necessary, so that device installation space can be reduced. The shaving process may be divided in a plurality of times. Accordingly, the takt time can be shortened as described above.

In the gear machining method according to the third (and fourth) embodiment, accurate machining can be conducted by separately conducting the tooth-face-finishing step before and after the thermal treatment.

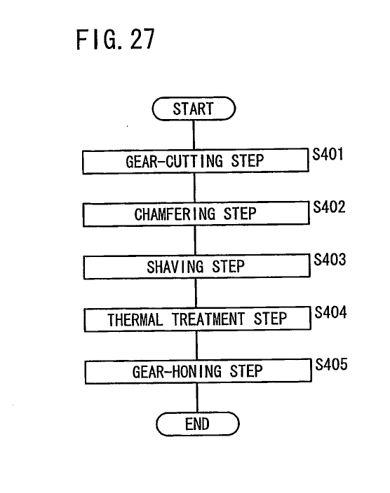

As shown in FIG. 27, the gear machining method according to the fourth embodiment comprises a gear-cutting step (step S401), a chamfering step (step S402), a shaving step (step S403, a first tooth-face-finishing step), a thermal treatment step (step S404), and a gear-honing step (step 5405, second tooth-face-finishing step). The steps correspond to the steps S301, S302, S303, S304 and S306 of the gear machining method according to the third embodiment shown in FIG. 26, where the gear-grinding step of the step S305 is skipped.

In the gear machining method according to the fourth embodiment, since the chamfering in the step S402 considerably restrains the formation of the swollen portion 80 (FIG. 14) and the shaving is conducted in the subsequent step S403, substantially no swollen portion 80 is existed. Accordingly, even when the gear-grinding step is skipped, the load applied on the internal-tooth grinding stone 182 during the subsequent gear-honing (step S405) is negligibly small in practical sense.

Incidentally, the tooth-face-finishing process after the thermal treatment is not limited to the gear-grinding step and the gear-honing step, but may be selected from at least one of processes capable of finishing the tooth face such as finishing-hob process or reaming process and the like in accordance with process condition. It should be understood that end-cutting step, inner-diameter honing step and the like may be conducted in addition to the explicitly mentioned steps in the above embodiments.

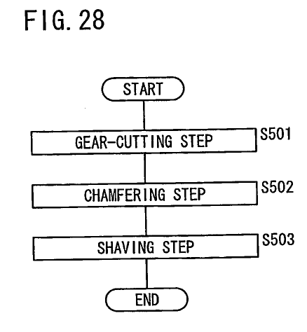

As shown in FIG. 28, the gear machining method according to a fifth embodiment includes gear-cutting step (step S501), chamfering step (step S502), and shaving step (step S503, first tooth-face-finishing process) conducted in this order. These steps corresponds to the steps S301, S302 and S303 in the gear machining method according to the third embodiment shown in FIG. 26, where the thermal treatment in the step S304, the gear-grinding in the step S305 and the gear-honing in the step 5306 are skipped.

Though no thermal treatment is conducted in the gear machining method according to the fifth embodiment, the gear machining method can be sufficiently applied on a gear that does not require so much high accuracy. Since the swollen portion is hardly existed in the shaving process (step S503) conducted after the chamfering step (step S502), the load applied on the shaving cutters 112, 114 and the like becomes low, making it possible to lengthen the tool life. Accordingly, the frequency for stopping the gear machining apparatuses 10a to 10c for tool exchanging work and maintenance/check frequency can be reduced and tool cost can be reduced.

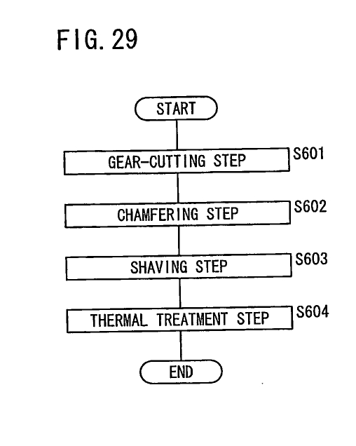

As shown in FIG. 29, the gear machining method according to a sixth embodiment includes a gear-cutting step (step S601), a chamfering step (step S602), a shaving step (step S603, a first tooth-face-finishing step) and a thermal treatment step (step S604) conducted in this order. These steps corresponds to the steps S301, S302, S303 and 304 in the gear machining method according to the third embodiment shown in FIG. 26, where the gear-grinding step of S305 and the gear-honing step of the step S306 are skipped.

Though no tooth-face-finishing step after the thermal treatment is provided in the gear machining method according to the sixth embodiment, the gear machining method can be applied for producing a gear that requires not so much accuracy but requires sufficient durability, by virtue of increased hardness of the workpiece gear 14 by the thermal treatment process. It should be appreciated that conducting the tooth-face-finishing step after the thermal treatment as in the third embodiment is preferable in order to provide a gear suitable for highly accurate vehicle gearbox.

Incidentally, the tooth-face-finishing step after the thermal treatment is not limited to the gear-grinding process and the gear-honing process, but may be selected from at least one of processes capable of finishing the tooth face such as finishing-hob process or reaming process and the like in accordance with process condition. It should be understood that end-cutting step, inner-diameter honing step and the like may be conducted in addition to the explicitly mentioned processes in the above embodiments.

As described above, since the chamfering cutter 18 meshes with the workpiece gear 14 at the axis-crossing angle ψ in the gear machining method according to the present embodiment, the chamfering cutter 18 not only collapses the end edges 30, 31 of the workpiece gear 14 but also restrains the formation of the swollen portion on account of excess material caused by the collapsing.

Since the gears obtained by the gear machining apparatuses 10a to 10c according to the present embodiment exhibits great hardness after thermal treatment, the gears are suitably used for a highly accurate vehicle gearbox in which high output, silence and durability are required.

On the other hand, since the gears that require not so much accuracy and experience no thermal treatment hardly generates the swollen portion during the chamfering process by the gear machining apparatuses 10a to 10c, only a small load is applied on the tool during the tooth-face-finishing such as shaving, so that tool life can be prolonged. Accordingly, the frequency for stopping the gear machining apparatuses for tool exchanging work and maintenance/check frequency can be reduced and tool cost can be reduced.

Further, it should be appreciated that the machining by the gear machining apparatuses 10a to 10c are effective to gears which require not so much high accuracy and which experience thermal treatment without accompanying tooth-face-finishing thereafter.

Since the formation of the swollen portion 80 can be prevented by the chamfering using the chamfering cutter 18, further precise gear can be produced by conducting the gear-honing even when the shaving process and gear-grinding process are skipped. In this case, since there is substantially no swollen portion 80 on the workpiece gear 14, the influence on the tool of the subsequent gear machining process (e.g., shaving process, gear-grinding process and gear-honing process) can be considerably small.

It should be understood that the gear machining apparatus and the gear machining method according to the present invention are not limited to the above specific embodiments, but may be variously modified and provided with various steps as long as an object of the present invention can be achieved.

1. A gear machining apparatus, comprising:
a workpiece support that pivotally supports a workpiece gear; and
a cutter support that pivotally supports a chamfering cutter so that the chamfering cutter meshes with the workpiece gear attached to the workpiece support,
the cutter support being angled so that the chamfering cutter meshes with the workpiece gear at an axis-crossing angle (ψ) not being zero degree and teeth of the chamfering cutter do not interfere with a tooth face of the workpiece gear.

2. The gear machining apparatus according to claim 1, wherein
the axis-crossing angle (ψ) is represented by the following formula:
$$Ψ ≦ {cos}^{- 1} \{ \frac{( \frac{D B G \times π}{Zg} - S B G ) + A \times tan ( B O G ) - {1}_{2} \times tan ( B O G )}{S K C} \} \qquad ( 2 )$$
where: BOG represents a gear deflection angle; SBG represents a circular thickness on a pitch circle; DBG represents a gear pitch circle diameter of the workpiece gear; l₂ represents a lap value; SKC represents a tooth-tip width of machining teeth of the chamfering cutter; Zg represents a tooth number of the workpiece gear; and A represents a chamfering amount.

3. The gear machining apparatus according to claim 1, wherein each face of the teeth of the chamfering cutter has an involute surface having no edge as a cutting edge.

4. The gear machining apparatus according to claim 1, wherein the axis-crossing angle (ψ) is in a range of 5° to 8°.

5. A gear machining apparatus, comprising:
a workpiece support that pivotally supports a workpiece gear; and
a first machining unit and a second machining unit that move relative to the workpiece support to sequentially machine the workpiece gear,
the first machining unit comprising a cutter support that pivotally supports the chamfering cutter so that the chamfering cutter meshes with the workpiece gear attached to the workpiece support,
the cutter support being angled so that the chamfering cutter meshes with the workpiece gear at an axis-crossing angle (ψ) and teeth of the chamfering cutter do not interfere with a tooth face of the workpiece gear,
the second machining unit comprising a shaving cutter that machines the tooth face of the workpiece gear.

6. The gear machining apparatus according to claim 5, further comprising a third machining unit that is moved relative to the workpiece support to machine the workpiece gear after the second machining unit machines the workpiece gear,
the third machining unit comprising a shaving cutter that machines the tooth face of the workpiece gear,
the workpiece support including at least three workpiece supports corresponding to the first machining unit, the second machining unit and the third machining unit, the workpiece gear including three workpiece gears, the first machining unit, the second machining unit and the third machining unit simultaneously machining the three workpiece gears.

7. The gear machining apparatus according to claim 5, wherein the workpiece support is provided on a rotary base, orientation of which is adjustable relative to the first machining unit.

8. The gear machining apparatus according to claim 5, wherein the workpiece gear is a helical gear.

9. The gear machining apparatus according to claim 8, wherein the workpiece gear is a gear for a vehicle gearbox.

10. The gear machining apparatus according to claim 5, wherein the chamfering cutter and the shaving cutter are provided on a turret mechanism and are moved in accordance with a rotation of the turret mechanism to sequentially face the workpiece support to process the workpiece gear.

11. The gear machining apparatus according to claim 10, wherein the workpiece support is provided beneath the turret mechanism and the turret mechanism is lowered to mesh the chamfering cutter and the shaving cutter with the workpiece gear.

12. The gear machining apparatus according to claim 10, wherein the rotary axis of the turret mechanism is angled relative to an axis of the workpiece support at an axis-crossing angle (ψ).

13. The gear machining apparatus according to claim 10, further comprising a third machining unit provided independent of the turret mechanism, the third machining unit being moved relative to the workpiece support to machine the workpiece gear after the second machining unit machines the workpiece gear,
wherein the third machining unit comprises a shaving cutter that machines the tooth face of the workpiece gear, and
the workpiece support includes at least two workpiece supports corresponding to the turret mechanism and the third machining unit, the workpiece gear including two workpiece gears, the turret mechanism and the third machining unit simultaneously machining the two workpiece gears.

14. The gear machining apparatus according to claim 10, further comprising a third machining unit that is moved relative to the workpiece support to machine the workpiece gear after the second machining unit machines the workpiece gear,
wherein the third machining unit comprises a shaving cutter that machines the tooth face of the workpiece gear, and
the chamfering cutter of the first machining unit, the shaving cutter of the second machining unit and the shaving cutter of the third machining unit are respectively provided on the turret mechanism.

15. The gear machining apparatus according to claim 5, wherein the workpiece support is not provided with a rotary drive source of the workpiece gear and the workpiece gear meshes with the chamfering cutter to follow the rotation thereof.

16. The gear machining apparatus according to claim 5, further comprising a roller cutter unit that brings two roller cutters into contact with the workpiece gear in a direction different from the cutter support to remove burrs on the workpiece gear.

17. A gear machining method, comprising:
a chamfering step for chamfering an end edge of a workpiece gear by rotating a chamfering cutter after meshing with the workpiece gear at an axis-crossing angle (ψ);
a thermally treating step for heating the workpiece gear after the chamfering step before shaping a tooth face; and
at least one tooth-face-finishing step for shaping the tooth face of the workpiece gear after the thermally treating step.

18. The gear machining method according to claim 17, wherein each of the teeth of the chamfering cutter is an involute surface having no edge as a cutting edge.

19. The gear machining method according to claim 17, wherein
the tooth-face-finishing step is at least one of a finishing-hob process, a gear-grinding process, a honing process and a reaming process.

20. The gear machining method according to claim 17, wherein a workpiece support for pivotally supporting the workpiece gear and a cutter support for pivotally supporting a chamfering cutter are used so that the workpiece gear attached to the workpiece support is meshed with the chamfering cutter, and
the cutter support meshes the chamfering cutter with the workpiece gear at an axis-crossing angle (ψ).

21. The gear machining method according to claim 20, wherein the workpiece support is provided on a rotary base, orientation of which is adjustable relative to the cutter support.

22. The gear machining method according to claim 17, wherein the workpiece gear is a helical gear.

23. The gear machining method according to claim 22, wherein the workpiece gear is a gear for a vehicle gearbox.

24. A gear machining method, comprising:
a chamfering step for chamfering an end edge of a workpiece gear by rotating a chamfering cutter while meshing with the workpiece gear at an axis-crossing angle (ψ); and
a first tooth-face-finishing step for shaping a tooth face of the workpiece gear after the chamfering step without subjecting to a thermal treatment.

25. The gear machining method according to claim 24, wherein the first tooth-face-finishing step is a shaving process.

26. The gear machining method according to claim 24, further comprising a thermally treating step for heating the workpiece gear after the first tooth-face-finishing step.

27. The gear machining method according to claim 26, further comprising at least one second tooth-face-finishing step for shaping the tooth face of the workpiece gear after the thermally treating step.

28. The gear machining method according to claim 27, wherein the second tooth-face-finishing step is at least one of a finishing-hob process, a gear-grinding process, a honing process and a reaming process.

29. The gear machining method according to claim 24, wherein a gear machining apparatus is used, including a workpiece support that pivotally supports the workpiece gear and a first machining unit and a second machining unit that move relative to the workpiece support to sequentially machine the workpiece gear, and
the chamfering step is conducted by the first machining unit and the first tooth-face-finishing step is conducted by the second machining unit.

30. The gear machining method according to claim 29, wherein the gear machining apparatus comprises a third machining unit that moves relative to the workpiece support to machine the workpiece gear after the first tooth-face-finishing step by the second machining unit,
the third machining unit comprises a shaving cutter that machines the tooth face of the workpiece gear, and
the workpiece support includes at least three workpiece supports corresponding to the first machining unit, the second machining unit and the third machining unit, the workpiece gear including three workpiece gears, the first machining unit, the second machining unit and the third machining unit simultaneously machining the three workpiece gears.

31. The gear machining method according to claim 29, wherein the first machining unit and the second machining unit are provided on a turret mechanism, the first machining unit and the second machining unit being sequentially moved to a position facing the workpiece support in accordance with a rotation of the turret mechanism to machine the workpiece gear.

32. The gear machining method according to claim 31, wherein a rotary axis of the turret mechanism is angled relative to an axis of the workpiece support at an axis-crossing angle (ψ).

33. The gear machining method according to claim 31, wherein the gear machining apparatus comprises a third machining unit independent of the turret mechanism, the third machining unit being moved relative to the workpiece support to machine the workpiece gear after the first tooth-face-finishing step by the second machining unit,
the third machining unit comprises a shaving cutter that machines the tooth face of the workpiece gear, and
the workpiece support includes at least two workpiece supports corresponding to the turret mechanism and the third machining unit, the workpiece gear including two workpiece gears, the turret mechanism and the third machining unit simultaneously machining the two workpiece gears.

34. The gear machining method according to claim 31, wherein the gear machining apparatus comprises a third machining unit that is moved relative to the workpiece support to machine the workpiece gear after the first tooth-face-finishing step by the second machining unit,
the third machining unit comprises a shaving cutter that machines the tooth face of the workpiece gear, and
the chamfering cutter of the first machining unit, the shaving cutter of the second machining unit and the shaving cutter of the third machining unit are respectively provided on the turret mechanism.
